(19) United States
(12) Patent Application Publication
(10) Pub. No.: US 2025/0016775 A1
(43) Pub. Date: Jan. 9, 2025

(54) METHOD AND APPARATUS FOR UPLINK TRANSMISSIONS IN WIRELESS COMMUNICATION SYSTEM

(71) Applicant: Samsung Electronics Co., Ltd., Gyeonggi-do (KR)

(72) Inventors: Sa ZHANG, Beijing (CN); Feifei SUN, Beijing (CN); Jingxing FU, Beijing (CN)

(21) Appl. No.: 18/709,652

(22) PCT Filed: Nov. 9, 2022
(86) PCT No.: PCT/KR2022/017579

§ 371 Date: May 13, 2024

(30) Foreign Application Priority Data
Nov. 12, 2021 (CN) 202111341451.8
Nov. 26, 2021 (CN) 202111424606.4
Dec. 1, 2021 (CN) 202111452692.X
Feb. 9, 2022 (CN) 202210122414.6
Feb. 16, 2022 (CN) 202210141827.9
Mar. 8, 2022 (CN) 202210219848.8

(51) Int. Cl. H04W 72/21; H04W 72/563

(52) U.S. Cl. CPC H04W 72/21; H04W 72/563

(57) ABSTRACT

A method and an apparatus for uplink transmissions in a wireless communication system are provided. The method includes receiving a downlink signal including at least one of downlink data or downlink control information (DCI); and determining uplink signals to be transmitted based on the downlink signal, and determining at least one of a time unit or an uplink channel for transmitting the uplink signal, wherein the uplink signal includes at least one of uplink data or uplink control information (UCI), and the uplink channel includes at least one of a physical uplink control channel (PUCCH) or a physical uplink shared channel (PUSCH); and performing an uplink transmission based on the determined uplink signals, and the determined time units and/or uplink channels. The invention can improve the efficiency of the uplink transmission.

### TECHNICAL FIELD

The present disclosure generally relates to the field of wireless communication, and in particular, to a method and an apparatus for uplink transmissions.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

In the prior art, there are still processing details to be refined for uplink transmission.

### Solution to Problem

According to at least one embodiment of the disclosure, there is provided a method for uplink transmissions performed by a terminal in a wireless communication system. The method includes receiving a downlink signal including at least one of downlink data or downlink control information (DCI); and determining uplink signals to be transmitted based on the downlink signal, and determining at least one of a time unit or an uplink channel for transmitting the uplink signal, where the uplink signal includes at least one of uplink data or uplink control information (UCI), and the uplink channel includes at least one of a physical uplink control channel (PUCCH) or a physical uplink shared channel (PUSCH); and performing an uplink transmission based on the determined uplink signals, and the determined time units and/or uplink channels.

According to some embodiments of the disclosure, there is also provided a terminal in a wireless communication system. The terminal includes a transceiver configured to transmit and receive signals; and a controller coupled with the transceiver and configured to perform one or more operations in the method performed by the terminal described above.

According to some embodiments of the disclosure, there is also provided a computer-readable storage medium having one or more computer programs stored thereon, wherein the one or more computer programs, when executed by one or more processors, can implement any of the methods described above.

### Advantageous Effects of Invention

The disclosure provides methods for a 5G or 6G communication system for supporting a higher data transmission rate.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to some embodiments of the disclosure;

FIG. 2A illustrates example wireless transmission and reception paths according to some embodiments of the disclosure;

FIG. 2B illustrates example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a second transceiving node according to embodiments of the disclosure;

FIG. 5 illustrates a flowchart of a method performed by a UE according to some embodiments of the disclosure;

FIG. 6A illustrates some examples of uplink transmission timing according to some embodiments of the disclosure;

FIG. 6B illustrates some examples of uplink transmission timing according to some embodiments of the disclosure;

FIG. 6C illustrates some examples of uplink transmission timing according to some embodiments of the disclosure;

FIG. 7A illustrates examples of time domain resource allocation tables according to some embodiments of the disclosure;

FIG. 7B illustrates examples of time domain resource allocation tables according to some embodiments of the disclosure;

FIG. 8 illustrates an example of uplink transmission overlapping according to some embodiments of the disclosure;

FIG. 9 illustrates a flowchart of a method for multiplexing and/or prioritizing PUCCHs according to some embodiments of the disclosure;

FIG. 10 illustrates an example of uplink transmission overlapping according to some embodiments of the disclosure;

FIG. 11A illustrates an example of uplink transmission overlapping according to some embodiments of the disclosure;

FIG. 11B illustrates an example of uplink transmission overlapping according to some embodiments of the disclosure;

FIG. 12 illustrates a flowchart of a method performed by a terminal according to some embodiments of the disclosure;

FIG. 13 illustrates a block diagram of a first transceiving node according to some embodiments of the disclosure; and

FIG. 14 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

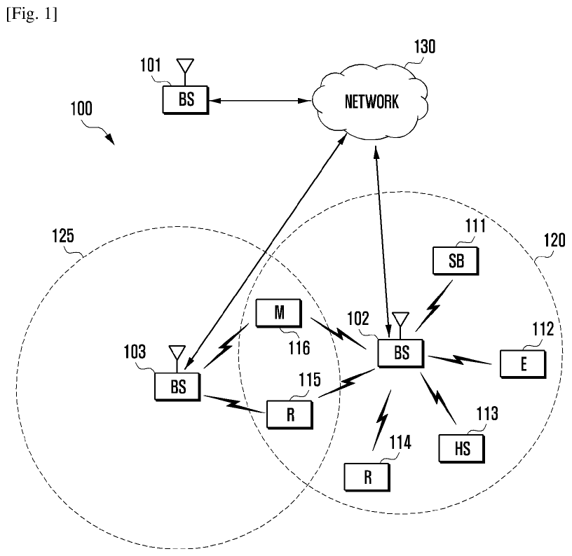

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

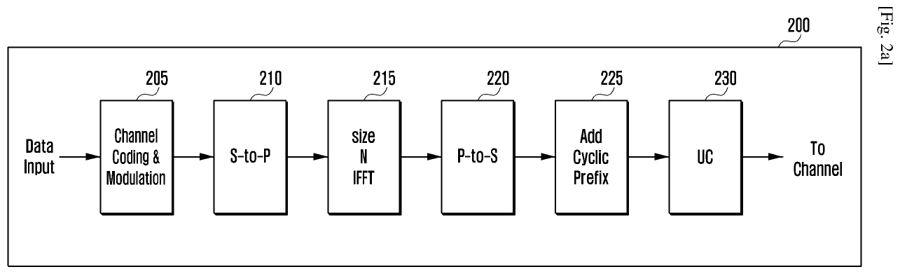

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

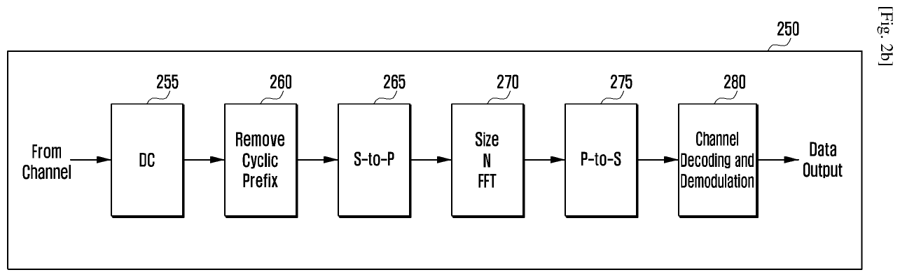

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a settop box and other devices.

Exemplary embodiments of the disclosure are further described below with reference to the drawings.

With the rapid development of information industry, especially the increasing demand from mobile Internet and internet of things (IoT), it brings unprecedented challenges to the future mobile communication technology. According to the report of International Telecommunication Union (ITU) ITU-R M.[IMT.BEYOND 2020.TRAFFIC], it can be predicted that by 2020, compared with 2010 (4G era), the growth of mobile traffic will be nearly 1000 times, and the number of UE connections will also exceed 17 billion, and the number of connected devices will be even more alarming, with the massive IoT devices gradually infiltrating into the mobile communication network. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In order to improve the reliability of PUCCH transmissions, a PUCCH may be configured with repetitions. At this time, how to perform UCI multiplexing and/or prioritization is an urgent problem to be solved.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

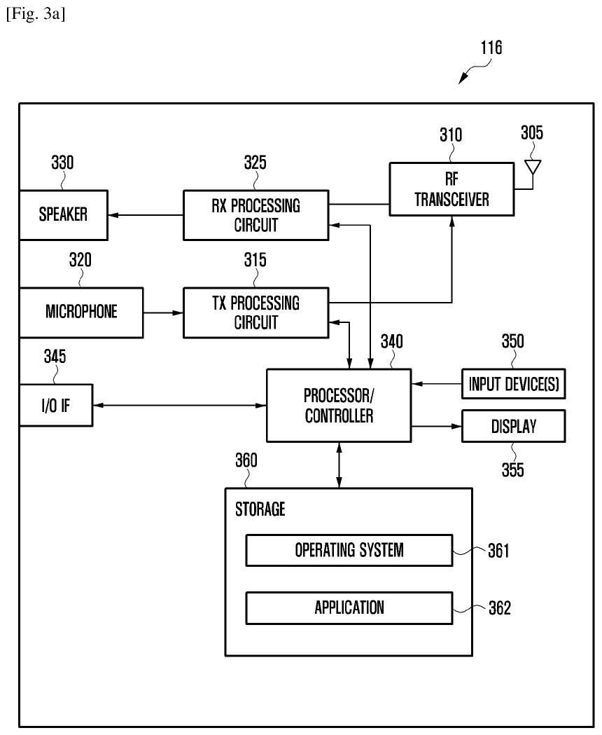

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

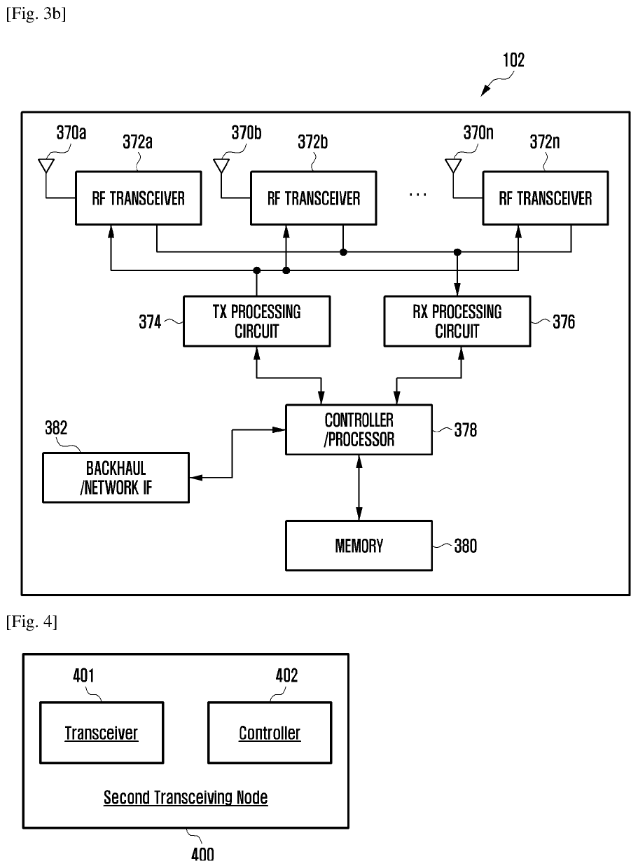

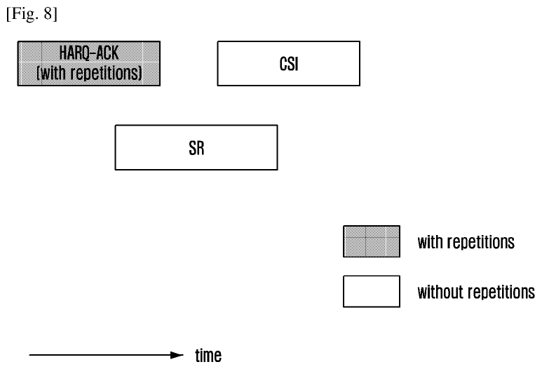

In some implementations, the controller 402 may be configured to perform one or more operations in methods of various embodiments described below. For example, the controller 402 may be configured to perform one or more of operations in a method 500 to be described later in connection with FIG. 5 and/or a method 1000 described in connection with FIG. 10.

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH carrying SR may be a PUCCH carrying positive SR and/or negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the first time unit and the second time unit may be one or more slots, one or more subslots, one or more OFDM symbols, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

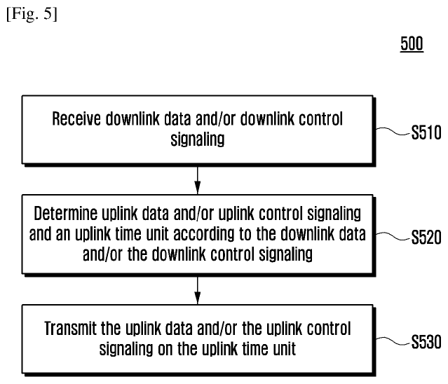

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a PUSCH scheduled by DCI (e.g., DG (dynamic grant) PUSCH) and/or a PUSCH not scheduled by DCI (e.g., CG PUSCH).

In yet another example, the UE receives the PDSCH, and may transmit HARQ-ACK information for the PDSCH in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH and the PDSCH, and K1 may be in units of uplink time units, such as slots or subslots. In a case where K1 is in units of slots, the time interval is a value of a slot offset between the PUCCH for feeding back the HARQ-ACK information for the PDSCH and the PDSCH. For example, FIG. 6A gives an example in which K1=3. In the example illustrated in FIG. 6A, the time interval between the PUCCH for transmitting the HARQ-ACK information for the PDSCH and the PDSCH is 3 slots. It should be noted that in embodiments of the disclosure, the timing parameter K1 may be used interchangeably with a timing parameter K₁, the timing parameter K0 may be used interchangeably with a timing parameter K₀, and the timing parameter K2 may be used interchangeably with a timing parameter K₂.

The PDSCH may be a PDSCH scheduled by the DCI and/or an SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the parameter K1 may be used to represent a time interval between the PUCCH for transmitting the HARQ-ACK information for the DCI and the DCI, and K1 may be in units of uplink time units, such as slots or subslots. For example, FIG. 6C gives an example in which K1=3. In the example of FIG. 6C, the time interval between the PUCCH for transmitting the HARQ-ACK information for the DCI and the DCI is 3 slots. For example, the parameter K1 may be used to represent a time interval between an SPS PDSCH reception and the PUCCH feeding back HARQ-ACK for the SPS PDSCH reception, where K1 is indicated in DCI activating the SPS PDSCH reception. In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (for example, in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission. For example, the two levels of priorities may include a first priority and a second priority which are different from each other. In an example, the first priority may be higher than the second priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

In some implementations, the UE may be configured with a subslot-based PUCCH transmission. For example, a subslot length parameter (which may also be referred to as a parameter related to a subslot length in embodiments of the disclosure) (e.g., the parameter subslotLengthForPUCCH in 3GPP) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of this PUCCH configuration parameter is one slot by default. If a subslot length parameter is configured in the PUCCH configuration parameter, the scheduling time unit of this PUCCH configuration parameter is L (L is the configured subslot configuration length) OFDM symbols.

The mechanism of slot-based PUCCH transmissions is basically the same as that of subslot-based PUCCH transmissions. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the parameter subslotLengthForPUCCH in 3GPP), unless otherwise indicated, a number of symbols contained in the slot of the PUCCH transmission is indicated by the subslot length parameter.

For example, if the UE is configured with the subslot length parameter, and subslot n is the last uplink subslot overlapping with a PDSCH reception or PDCCH reception (e.g., for SPS PDSCH release, and/or indicating secondary cell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast/broadcast may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). The unicast PDSCH may also be a unicast SPS PDSCH. A multicast/broadcast PDSCH may be a PDSCH received by more than one UE simultaneously, and the scrambling of the multicast/broadcast PDSCH may be based on a UE-group common RNTI. For example, the UE-group common RNTI for scrambling the multicast/broadcast PDSCH may include an RNTI (referred to as G-RNTI in embodiments of the disclosure) for scrambling of a dynamically scheduled multicast/broadcast transmission (e.g., PDSCH) or an RNTI (referred to as G-CS-RNTI in embodiments of the disclosure) for scrambling of a multicast/broadcast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH. UCI(s) of the multicast (or groupcast)/broadcast PDSCH may include HARQ-ACK information for the multicast/broadcast PDSCH. In embodiments of the disclosure, “multicast/broadcast” may refer to at least one of multicast or broadcast.

In some implementations, a HARQ-ACK codebook may include HARQ-ACK information for one or more PDSCHs and/or DCI. If the HARQ-ACK information for the one or more PDSCHs and/or DCI is transmitted in a same uplink time unit, the UE may generate the HARQ-ACK codebook based on a predefined rule. For example, if a PDSCH is successfully decoded, the HARQ-ACK information for this PDSCH is positive ACK. The positive ACK may be represented by 1 in the HARQ-ACK codebook, for example. If a PDSCH is not successfully decoded, the HARQ-ACK information for this PDSCH is Negative ACK (NACK). NACK may be represented by 0 in the HARQ-ACK codebook, for example. For example, the UE may generate the HARQ-ACK codebook based on the pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits the HARQ-ACK information (ACK) for the DCI format. In yet another example, if the UE receives a DCI format that indicates to transmit HARQ-ACK information (e.g., a Type-3 HARQ-ACK codebook in 3GPP) of all HARQ-ACK processes of all configured serving cells, the UE transmits the HARQ-ACK information of all HARQ-ACK processes of all configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of a SPS PDSCH, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B’” may mean that ‘A’ overlaps with ‘B’ in time domain and/or ‘A’ overlaps with ‘B’ in frequency domain.

In some implementations, if HARQ-ACK information transmitted in a same uplink time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same uplink time unit only includes HARQ-ACK information for one or more SPS PDSCH receptions, the UE may generate HARQ-ACK information according to a rule for generating a SPS PDSCH HARQ-ACK codebook.

In some implementations, if HARQ-ACK information transmitted in a same uplink time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook in 3GPP) or a dynamic HARQ-ACK codebook (e.g., Type-2 HARQ-ACK codebook in 3GPP) according to a PDSCH HARQ-ACK codebook configuration parameter (e.g., the parameter pdsch-HARQ-ACK-Codebook in 3GPP). The dynamic HARQ-ACK codebook may also be an enhanced dynamic HARQ-ACK codebook (e.g., Type-2 HARQ-ACK codebook based on grouping and HARQ-ACK retransmission in 3GPP).

In some implementations, if HARQ-ACK information transmitted in a same uplink time unit includes only HARQ-ACK information for a SPS PDSCH (e.g., a PDSCH not scheduled by a DCI format), the UE may generate the HARQ-ACK codebook according to a rule for generating a HARQ-ACK codebook for a SPS PDSCH reception (e.g., the pseudo code for generating a HARQ-ACK codebook for a SPS PDSCH reception defined in 3GPP).

The semi-static HARQ-ACK codebook (e.g., 3GPP TS 38.213 Type-1 HARQ-ACK codebook) may determine the size of the HARQ-ACK codebook and an order of HARQ-ACK bits according to a semi-statically parameter (e.g., a parameter configured by higher layer signaling). For a serving cell c, an active downlink BWP (bandwidth part) and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) HARQ-ACK slot timing values K1 of the active uplink BWP;
b) a downlink time domain resource allocation (TDRA) table;
c) an uplink SCS configuration and a downlink SCS configuration;
d) a semi-static uplink and downlink frame structure configuration;
e) a downlink slot offset parameter (e.g., 3GPP parameter N_{slot,offset,c}^{DL}) for the serving cell c and its corresponding slot offset SCS (e.g., 3GPP parameter μ_{offset,DL,c}), and a slot offset parameter (e.g., 3GPP parameter N_{slot,offset}^{UL}) for a primary serving cell and its corresponding slot offset SCS (e.g., 3GPP parameter μ_{offset,UL}).

The parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlap with the candidate uplink slot in time domain. It should be noted that, in embodiments of the disclosure, a start symbol may be used interchangeably with a start position, and an end symbol may be used interchangeably with an end position. In some implementations, the start symbol may be replaced by the end symbol, and/or the end symbol may be replaced by the start symbol.

A number of PDSCHs in a candidate downlink slot for which HARQ-ACK needs to be fed back is determined by a maximum value of a number of non-overlapping valid PDSCHs in the downlink slot (for example, the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by DCI. Each row in the time domain resource allocation table may define information related to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a start symbol and allocation length. For example, for the first row of the time domain resource allocation table, a start OFDM symbol is 0 and an OFDM symbol length is 4; for the second row of the time domain resource allocation table, the start OFDM symbol is 4 and the OFDM symbol length is 4; and for the third row of the time domain resource allocation table, the start OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook needs to feed back HARQ-ACK information for two PDSCHs in the downlink slot of the serving cell.

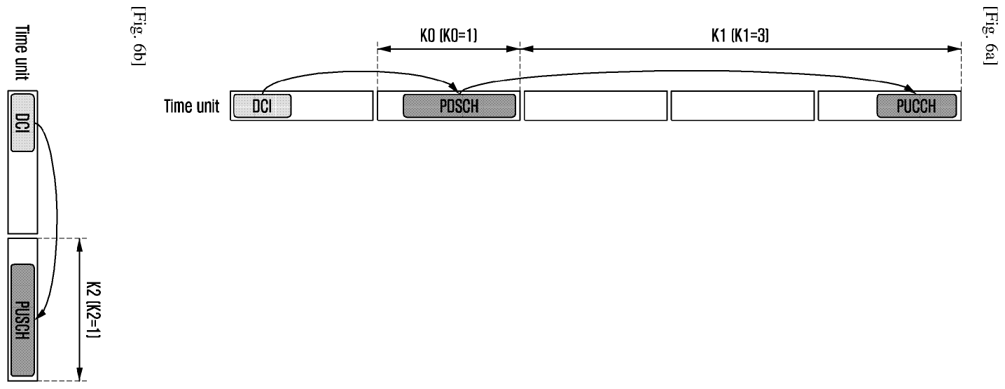

FIGS. 7A and 7B illustrate examples of a time domain resource allocation table. Specifically, FIG. 7A illustrates a time domain resource allocation table in which one PDSCH is scheduled by one row, and FIG. 7B illustrates a time domain resource allocation table in which multiple PDSCHs are scheduled by one row. Referring to FIG. 7A, each row corresponds to a value of a timing parameter K0, a value of S indicating a start symbol, and a value of L indicating a length, where an SLIV may be determined by the value of S and the value of L. Referring to FIG. 7B, unlike FIG. 7A, each row corresponds to values of multiple sets of {K0, S, L}.

In some implementations, the dynamic HARQ-ACK codebook and/or the enhanced dynamic HARQ-ACK codebook may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (for example, the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as UL DAI.

In the following examples, the first DAI as the C-DAI and the second DAI as the T-DAI are taken as an example for illustration, but the examples are not limited thereto.

Tables 1 and 2 show a correspondence between the DAI field and V_{T-DAI,m} or V_{C-DAI,c,m}. Numbers of bits of the C-DAI and T-DAI are limited.

For example, in a case where the C-DAI or T-DAI is represented with 2 bits, the value of the C-DAI or T-DAI in the DCI may be determined by equations in Table 1. V_{T-DAI,m} is the value of the T-DAI in DCI received in a PDCCH Monitoring Occasion (MO) m, and V_{C-DAI,c,m} is the value of the C-DAI in DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| MSB, LSB of | V_{T-DAI, m} or | |
|---|---|---|
| DAI Field | V_{C-DAI, c, m} | Y |
| 0, 0 | 1 | (Y-1)mod4 + 1 = 1 |
| 0, 1 | 2 | (Y-1)mod4 + 1 = 2 |
| 1, 0 | 3 | (Y-1)mod4 + 1 = 3 |
| 1, 1 | 4 | (Y-1)mod4 + 1 = 4 |

For example, when the C-DAI or T-DAI is 1, 5 or 9, as shown in Table 1, all of the DAI field are indicated with “00”, and the value of V_{T-DAI,m} or V_{C-DAI,c,m} is represented as “1” by the equation in Table 1. Y may represent the value of the DAI corresponding to the number of DCIs actually transmitted by the base station (the value of the DAI before conversion by the equation in the table). For example, in a case where the C-DAI or T-DAI in the DCI is 1 bit, values greater than 2 may be represented by equations in Table 2.

TABLE 2

| DAI | V_{T-DAI, m} or | |
|---|---|---|
| field | V_{C-DAI, c, m} | Y |
| 0 | 1 | (Y-1)mod2 + 1 = 1 |
| 1 | 2 | (Y-1)mod2 + 1 = 2 |

It should be noted that, unless otherwise specified, methods in embodiments of the disclosure may be specified by protocols and/or configured by higher layer signaling and/or indicated by dynamic signaling. For example, the dynamic signaling may be DCI/PDCCH. As an example, for an SPS PDSCH and/or a CG PUSCH, it may be dynamically indicated in active DCI/DCI format/PDCCH for the SPS PDSCH and/or the CG PUSCH. All or one or more of the described methods, steps and operations may be optional. For example, if a parameter X is configured by higher layer signaling, the UE performs approach A, otherwise (if the parameter X is not configured by the higher layer signaling), the UE performs approach B.

It should be noted that, a PCell (Primary Cell) or PSCell (Primary Secondary Cell) in embodiments of the disclosure may be used interchangeably with a Cell having a PUCCH.

It should be noted that, methods for downlink in embodiments of the disclosure may also be applicable to uplink, and methods for uplink may also be applicable to downlink. For example, a PDSCH may be replaced with a PUSCH, an SPS PDSCH may be replaced with CG PUSCH, and downlink symbols may be replaced with uplink symbols, so that methods for downlink may be applicable to uplink.

It should be noted that, methods applicable to multiple PDSCH/PUSCH scheduling in embodiments of the disclosure may also be applicable to a PDSCH/PUSCH transmission with repetitions. For example, a PDSCH/PUSCH of multiple PDSCH/PUSCHs may be replaced by a repetition of multiple repetitions of the PDSCH/PUSCH transmission.

It should be noted that, steps of methods according to embodiments of the disclosure may be implemented in any order.

It should be noted that, in methods of the disclosure, a DCI format schedules multiple PDSCHs/PUSCHs, which may be multiple PDSCHs/PUSCHs of a same serving cell and/or multiple PDSCHs/PUSCHs of different serving cells.

It should be noted that, in methods of the disclosure, “canceling a transmission” may mean canceling the transmission of the entire uplink channel and/or canceling the transmission of a part of the uplink channel.

It should be noted that, in methods of the disclosure, an “ascending order” may be replaced by a “descending order”, and/or a “descending order” may be replaced by an “ascending order”.

It should be noted that, in methods of the disclosure, a PUCCH/PUSCH carrying A (or with A) may be understood as a PUCCH/PUSCH only carrying A (or with A), and may also be understood as a PUCCH/PUSCH including at least A.

It should be noted that, in methods of the disclosure, for a noun, methods of the disclosure may be applicable to one and/or multiple such nouns. The article “a” may also be replaced by “multiple” or “more than one”, and “multiple” or “more than one” may also be replaced by “a”.

In some cases, if at least one PUCCH of multiple PUCCHs (for example, each of the multiple PUCCHs may carry different or same UCI(s), such as HARQ-ACK information, SR or CSI) in a time unit is configured with repetitions (repetition transmissions), where one or more PUCCHs of the at least one PUCCH overlap with another one or more PUCCHs in time domain, how to perform multiplexing and/or prioritization of PUCCHs and/or PUSCHs is a problem to be solved.

It should be noted that in embodiments of the disclosure, “configured and/or indicated with repetitions” (or “configured and/or indicated with repetition transmissions”) may be understood as a number of repetitions (repetition transmissions) is greater than 1. For example, “a PUCCH that is configured and/or indicated with repetitions” (or “a PUCCH transmission that is configured and/or indicated with repetitions”) may be replaced by “a PUCCH repeatedly transmitted over more than one slot/subslot”. “Not configured and/or indicated with repetitions” may be understood as a number of repetitions (repetition transmissions) is equal to 1. For example, “a PUCCH that is not configured and/or indicated with repetitions” may be replaced by “a PUCCH transmission with a number of repetitions being 1”. For example, the UE may be configured with a parameter N_{PUCCH}^{repeat} related to a number of repetitions of a PUCCH transmission; when the parameter N_{PUCCH}^{repeat} is greater than 1, it may mean that the UE is configured with a PUCCH transmission with repetitions, and the UE may repeat the PUCCH transmission in N_{PUCCH}^{repeat} time units (e.g., slots); when the parameter is equal to 1, it may mean that the UE is not configured with a PUCCH transmission with repetitions. For example, the repeatedly transmitted PUCCH may contain only one type of UCI(s).

In some implementations, it may be specified by protocols and/or configured by higher layer signaling that a PUCCH and/or PUSCH to be transmitted may be determined by at least one of the following Manners MN1˜MN7.

### Manner MN1 (Herein, it May Also be Referred as a First Manner)

In Manner MN1, the PUCCH and/or PUSCH to be transmitted may be determined according to one or more of the following steps.

Step A-1: multiplexing and/or prioritizing PUCCHs that are not configured with repetitions in a time unit. After step A-1 is performed, the PUCCHs that are not configured with repetitions in the time unit do not overlap in time domain. In embodiments of the disclosure, prioritizing of multiple PUCCHs may mean determining transmission priorities of the multiple PUCCHs, and determining a transmission order of each PUCCH based on the determined transmission priority of the PUCCH and/or determining whether to transmit the PUCCH.

Step A-2: multiplexing and/or prioritizing PUCCHs in the time unit.

It should be noted that, unless otherwise specified, in embodiments of the disclosure, each step is optional.

It should be noted that, unless otherwise specified, in embodiments of the disclosure, each step may be performed when a predefined condition is satisfied, and if the predefined condition is not satisfied, the step is not performed. For example, in step A1, if there are no PUCCHs that overlap in time domain and there are no PUCCHs that are configured with repetitions, the UE does not perform step A-1. If there are multiple PUCCHs that overlap in time domain and are not configured with repetitions, the UE performs step A-1.

It should be noted that in embodiments of the disclosure, unless otherwise specified, PUCCHs may be PUCCHs with a same priority. The PUCCHs may also be PUCCHs with different priorities. The PUCCH may be a PUCCH with a lower priority. The PUCCH may be a PUCCH with a higher priority.

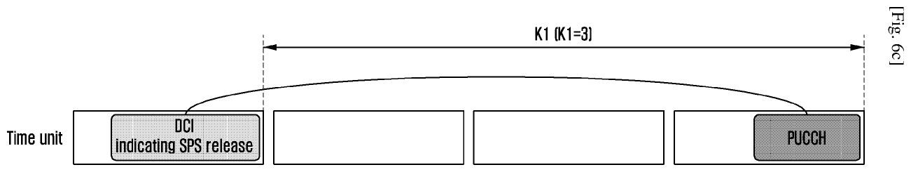

The method is simple to implement, and can avoid cancellation of UCI transmission. For example, as shown in FIG. 8, when a PUCCH for HARQ-ACK is configured with repetitions, and a PUCCH for SR and a PUCCH for CSI are not configured with repetitions, the SR may first be multiplexed in the PUCCH for CSI, and then the UE may transmit the UCIs (including HARQ-ACK, SR and CSI) simultaneously. Therefore, the method can improve the reliability of uplink transmission.

### Manner MN2 (Herein, it May Also be Referred as a Second Manner)

In Manner MN2, according to a predefined rule, a predetermined number (e.g., 2) or more than the predetermined number (e.g., 2) of PUCCHs are selected, and the selected PUCCHs are multiplexed and/or prioritized. The predefined rule may be the rule for selecting PUCCHs specified in 3GPP TS 38.213 9.2.5, but it is not limited thereto.

### Manner MN3 (Herein, it May Also be Referred as a Third Manner)

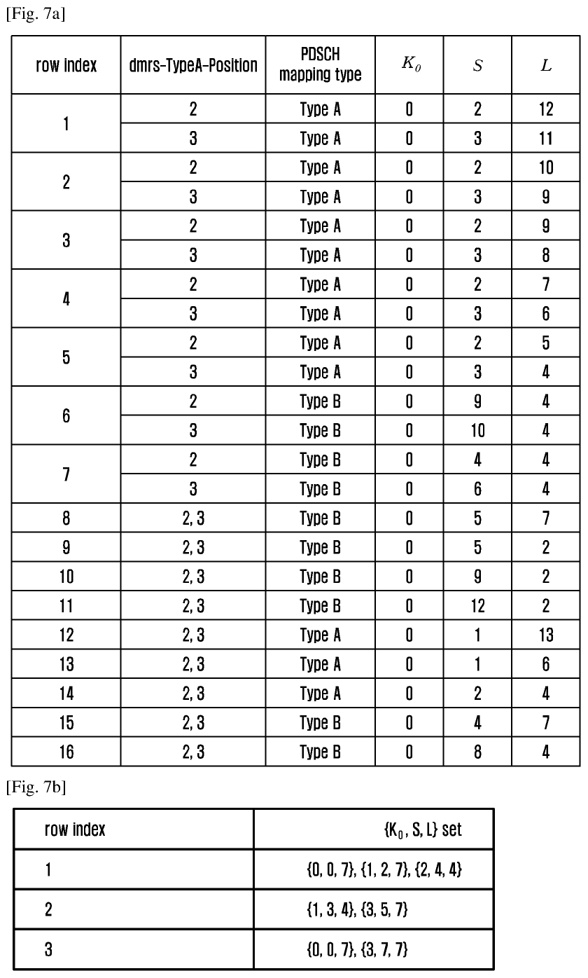

In Manner MN3, according to a predefined rule, a predetermined number (e.g., 2) of PUCCHs are selected, and the selected PUCCHs are multiplexed and/or prioritized. The predefined rule may be the rule for selecting PUCCHs specified in 3GPP TS 38.213 9.2.5, but it is not limited thereto. A specific implementation of Manner MN3 will be described below with reference to FIG. 9.

For example, referring to FIG. 9, in step S910, a set of resources Q (which may be referred as an initial set Q) for transmitting respective PUCCHs in a time unit is determined. For example, all PUCCHs in a time unit (or resources for transmitting respective PUCCHs in the time unit, that is, PUCCH resources in the time unit) may be placed (e.g., included) into the set Q (e.g., the initial set Q). In embodiments of the disclosure, a PUCCH, a resource and a PUCCH resource may be used interchangeably.

Then, in step S920, PUCCH(s) are selected in the set Q, for example, according to a predefined rule. For example, a resource j may be selected based on indexes of PUCCHs in the set Q.

Next, in step S930, whether a number (e.g., counter) of resources for the selected PUCCH(s) overlapping with the PUCCH resource j is equal to zero (i.e., there is no overlapping resource) (which may correspond to a number of the selected PUCCH(s) being equal to the predetermined number (e.g., 2)) is determined. When the number (e.g., counter) of overlapping resources is not equal to zero, it may return to operation S920 to continue. When the number (e.g., counter) of the overlapping resources is equal to zero, that is, the number of the selected PUCCH(s) is not equal to (or less than) the predetermined number (e.g., 2), and a resource overlapping with the resources in time domain is selected in a predefined order (e.g., an increasing order of a number j in pseudo codes as described below), a resulting PUCCH is determined by multiplexing and/or prioritizing the selected PUCCH(s) in operation S940.

Then, in step S950, the set Q is updated based on the resulting PUCCH. For example, the resulting PUCCH may be placed (e.g., included) into the set Q and the selected PUCCH(s) may be deleted to update the set Q.

Next, in step S960, whether a predetermined condition is satisfied is determined. For example, the predetermined condition may include that there is no overlapping PUCCH in the set Q. If the predetermined condition is satisfied, that is, there is no overlapping PUCCH in the set Q, the set Q is determined as a final set Q for uplink transmission in step S970. Otherwise, if the predetermined condition is not satisfied, it returns to step S920. Therefore, the process (e.g., steps S920˜S940) may be repeated until the predetermined condition is satisfied, that is, there is no overlapping PUCCH in the set Q. The resources in the set Q (final set Q) when the predetermined condition is satisfied (for example, when there is no overlapping PUCCH in the set Q) may be determined for uplink transmission.

It should be noted that “PUCCH in set Q” and “resource in set Q” may be used interchangeably.

For example, elements in the set Q may be arranged based on at least one of the following orders:
a resource of with earlier first symbol is placed before a resource with earlier first symbol;
for two resources with same first symbol, a resource with longer duration is placed before a resource with shorter duration;
for two resources with same first symbols and same duration, the placement may be arbitrary;
a PUCCH including HARQ-ACK with a higher priority is placed first (or before other resources).

For example, the set Q (which may be a set Q1) may be traversed and resources for UE transmission may be determined according to the following pseudo code-1 (corresponding to the method described above in connection with FIG. 9). In pseudo code-1, “\” is a difference set operator, for example, A\B may represent removal of elements of a set B from a set A.

[Pseudo code-1]

```
Set c(Q) to the cardinality of set Q
Set j = 0 - index of first resource in set Q
Set o=0 - counter of overlapping resources
while j ≤ c(Q)−1
  if j < c(Q)−1 and resource Q(j−o) (or Q(j) ) overlaps with resource Q(j+1)
  and o is equal to 0
    o=o+1
    j=j+1
  else
    if o>0
      determine a resource for carrying UCI (for example, after
      multiplexing or prioritizing of resources {Q(j−o),Q(j−o+1),...,Q(j)} )
      associated with resources {Q(j−o),Q(j−o+1),...,Q(j)}. For example,
      the resources may be determined according to a method of
      multiplexing multiple PUCCHs in a PUCCH and/or prioritizing multiple
      PUCCHs according to embodiments of the disclosure. Alternatively,
      the resources may be determined according to the methods specified
      in 3GPP TS 38.213 9.2.5.0, 9.2.5.1, 9.2.5.2 and 9.2.6.
      set the index of the resource to j
      Q = Q \ {Q(j − o), Q(j − o + 1),..., Q(j − 1)}
      j=0
      o=0
      order(Q) % function that orders (or re-orders) resources in current
      set Q . For example, the ordering is performed according to the
      ordering methods or rules specified in embodiments of the
      disclosure. For another example, the ordering is performed according
      to the ordering rule specified in 3GPP TS 38.213 9.2.5.
      set c(Q) to the cardinality of set Q
    else
        j=j+1
    end if
  end if
end while
```

The function order(Q) is used to order (or re-order) the resources in the current set Q. The function order(Q) may be implemented by adopting any suitable ordering method. For example, the function order(Q) may be executed according to the following pseudo code-2.

[Pseudo code-2]

```
  {
k = 0
while k < c(Q)−1
  l = 0
  while l < c (Q)− 1 − k
    if Q(l,0) > Q(l + 1,0) OR (Q(l,0) = Q(l + 1,0) & L(Q(l))< L(Q(l +
    1)))
      temp = Q(l)
      Q(l) = Q(l + 1)
      Q(l + 1) = temp
    end if
  l=l+1
  end while
k = k + 1
end while
  }
```

### Manner MN17 (Herein, it May Also be Referred as a Seventeenth Manner)

In Manner MN17, PUCCHs satisfying a second predefined condition in a time unit is placed (e.g., included) into the set Q. For PUCCHs in the set Q, a predetermined number (e.g., 2) of PUCCHs are selected according to a predefined rule, and the selected PUCCHs are multiplexed and/or prioritized. The predefined rule may be the rule for selecting PUCCHs specified in 3GPP TS 38.213 9.2.5, but it is not limited thereto. The predefined rule may be based on pseudo code-1 and/or pseudo code-2, and thus PUCCHs may be selected from the set Q based on pseudo code-1 and/or pseudo code-2. The predefined rule may be based on pseudo code-3 and/or pseudo code-2, and thus PUCCHs may be selected from the set Q based on pseudo code-3 and/or pseudo code-2.

[Pseudo code-3]

```
Set c(Q) to the cardinality of set Q
Set Q(j,0) to be the first symbol of resource Q(j)
Set L(Q(j)) to be the number of symbols of resource Q(j)
Set j = 0 - index of first resource in set Q
Set o=0 - counter of overlapping resources
while j ≤ c(Q)−1
  if j < c(Q)−1 and resource Q(j−o) (or Q(j) ) overlaps with resource Q(j+1)
  and o is equal to 0
    o=o+1
    j=j+1
  else
    if o>0
      determine a resource for carrying UCI (for example, after
      multiplexing or prioritizing of resources {Q(j − 1), Q(j)})
      associated with resources {Q(j − 1), Q(j)}. For example, the
      resources may be determined according to a method of multiplexing
      multiple PUCCHs in a PUCCH and/or prioritizing multiple PUCCHs
    according to embodiments of the disclosure. Alternatively, the
    resources may be determined according to the methods specified in
    3GPP TS 38.213 9.2.5.0, 9.2.5.1, 9.2.5.2 and 9.2.6.
    set the index of the resource to j
    Q = Q [symbol]   Q(j − 1)
    j = 0
    o=0
    order(Q) % function that orders (or re-orders) resources in current
    set Q . For example, the ordering is performed according to the
    ordering methods or rules specifie|d in embodiments of the disclosure
    (e.g., pseudo code-2). For another example, the ordering is
    performed according to the ordering rule specified in 3GPP TS 38.213
    9.2.5.
    set c(Q) to the cardinality of set Q
else
    j = j + 1
end if
end if
end while
```

It should be noted that, in case that a PUCCH is configured with repetitions, in embodiments of the disclosure, a repetition of multiple repetitions of the PUCCH transmission may be regarded as a PUCCH (or PUCCH resource), or all repetitions of the PUCCH transmission may be regarded as a PUCCH (or PUCCH resource), or a specific repetition of the multiple repetitions of the PUCCH transmission may be regarded as a PUCCH (or PUCCH resource).

The second predefined condition may be at least one of:
the PUCCH is configured with repetitions.
the PUCCH overlaps with at least one PUCCH that is configured with repetitions
a priority of the PUCCH is a specific priority
a type of UCI(s) carried by the PUCCH is a specific type of UCI(s)
the PUCCH is within a time unit

The method is simple to implement and can improve the flexibility of scheduling.

### Manner MN18 (Herein, it May Also be Referred as a Eighteenth Manner)

In Manner MN18, the PUCCH and/or PUSCH to be transmitted may be determined according to one or more of the following steps.

Step C-1: multiplexing and/or prioritizing PUCCHs that are configured with repetitions and PUCCHs (e.g., PUCCHs that are not configured with repetitions) overlapping with the PUCCHs that are configured with repetitions in a time unit. For example, step C-1 may adopt other manners of the disclosure (e.g., Manner MN17 and/or Manner MN3). After step C-1 is performed, the PUCCHs that are configured with repetitions in the time unit does not overlap with other PUCCHs in time domain.

Step C-2: multiplexing and/or prioritizing PUCCHs that are not configured with repetitions in the time unit. For example, the PUCCHs that are not configured with repetitions in the time unit may be multiplexed and/or prioritized according to the methods specified in 3GPP TS 38.213. For another example, the PUCCHs that are not configured with repetitions in the time unit may be multiplexed and/or prioritized according to pseudo code-1 and/or pseudo code-2 and/or pseudo code-3.

The method is simple to implement and can avoid cancellation of UCI transmission. For example, it is assumed that the SR and CSI positions in FIG. 8 are interchanged. When a PUCCH for HARQ-ACK is configured with repetitions, and a PUCCH for SR and a PUCCH for CSI are not configured with repetitions, the UE may first cancel the transmission of the CSI, which can avoid multiplexing of the SR in the PUCCH for CSI, and then the UE cancels the transmission of the SR and CSI. Therefore, the method can improve the reliability of uplink transmission.

It should be noted that a certain way may be configured to be adopted by higher layer signaling parameters. For example, if a parameter X is configured, Manner MN1 (or 18) is adopted, otherwise (if the parameter X is not configured), Manner MN18 (or 1) is adopted.

### Manner MN4 (Herein, it May Also be Referred as a Fourth Manner)

In Manner MN4, it may be specified by protocols and/or configured by higher layer signaling that the UE does not expect that a first PUCCH that is configured with repetitions overlaps with a second PUCCH that is not configured with repetitions in time domain, and that the second PUCCH that is not configured with repetitions overlaps with a third PUCCH in time domain. The third PUCCH may be a PUCCH that is configured with repetitions and/or a PUCCH that is not configured with repetitions. The method is simple to implement and can reduce the complexity of UE implementation.

### Manner MN5 (Herein, it May Also be Referred as a Fifth Manner)

In Manner MN5, it may be specified by protocols and/or configured by higher layer signaling that the UE does not expect that a first PUCCH that is not configured with repetitions overlaps with a second PUCCH that is configured with repetitions in time domain, and that the second PUCCH that is configured with repetitions overlaps with a third PUCCH in time domain. The third PUCCH may be a PUCCH that is configured with repetitions and/or a PUCCH that is not configured with repetitions. The method is simple to implement and can reduce the complexity of UE implementation.

### Manner MN6 (Herein, it May Also be Referred as a Sixth Manner)

In Manner MN6, it may be specified by protocols and/or configured by higher layer signaling that the UE does not expect that a PUCCH that is not configured with repetitions overlaps with multiple PUCCHs in time domain, where at least one PUCCH of the multiple PUCCHs is configured with repetitions. The method is simple to implement and can reduce the complexity of UE implementation.

It should be noted that “multiple” may be understood as “more than one” in embodiments of the disclosure.

### Manner MN7 (Herein, it May Also be Referred as a Seventh Manner)

In Manner MN7, it may be specified by protocols and/or configured by higher layer signaling that the UE does not expect that a PUCCH that is configured with repetitions overlaps with multiple PUCCHs in time domain, where the multiple PUCCHs may be PUCCHs that are configured with repetitions and/or PUCCHs that are not configured with repetitions. The method is simple to implement and can reduce the complexity of UE implementation.

In some cases where a PUCCH that is configured with repetitions overlaps with another PUCCH in time domain, and the other PUCCH may contain various types of UCIs, it is necessary to consider how to prioritize PUCCHs. For example, PUCCHs may be prioritized in at least one of the following manners.

### Manner MN8 (Herein, it May Also be Referred as a Eighth Manner)

In Manner MN8, in case that a PUCCH contains multiple types of UCIs (e.g., HARQ-ACK, SR or CSI), the PUCCH may be prioritized based on a priority of a certain UCI type (e.g., a UCI type with the highest (or lowest) priority) of the multiple UCI types. That is, when the PUCCH including multiple types of UCIs is prioritized, only a specific type of UCI(s) (e.g., the type of UCI(s) with the highest (or lowest) priority) of the multiple types of UCIs may be considered. For example, an ordering priority of the PUCCH may be determined by the type of UCI(s) with the highest (or lowest) ordering priority among the multiple types of UCIs. Or, the PUCCH may be equivalent to a PUCCH including only the UCI(s) with the highest (or lowest) ordering priority among the multiple types of UCIs. Or, the PUCCH is processed based on that the PUCCH contains only the UCI(s) with the highest (or lowest) ordering priority among the multiple types of UCIs. For example, an ordering priority of different types of UCIs may be HARQ-ACK>SR>CSI with a higher priority (e.g., Part 1 CSI)>CSI with a lower priority (e.g., Part 2 CSI), that is, an priority order from high to low is {HARQ-ACK, SR, CSI of the higher priority (e.g., Part 1 CSI), CSI of the lower priority (e.g., Part 2 CSI)}. Then, the PUCCH and another PUCCH that is configured with repetitions may be prioritized, for example, according to the method specified in 3GPP TS 38.213 9.2.6. For example, for a same UCI type, the UE transmits the PUCCH starting at an earlier slot and does not transmit the PUCCH starting at a later slot, For different UCI types, the UE transmits the PUCCH that includes the UCI type with a higher ordering priority, and the UE does not transmit the PUCCH that includes the UCI type with a lower ordering priority.

The method is simple to implement, can reduce the complexity of UE implementation, clarifies the behavior of the UE, and can improve the reliability of uplink transmission.

In some cases where a PUCCH transmission that is configured with repetitions may overlap with a PUCCH and/or PUSCH transmission that is not configured with repetitions in time domain, as shown in FIG. 10, it is necessary to consider how to multiplex and/or prioritize PUCCHs/PUSCHs. In some implementations, PUCCHs/PUSCHs may be multiplexed and/or prioritized based on at least one of the following Manners MN9˜MN11.

### Manner MN9 (Herein, it May Also be Referred as a Ninth Manner)

In Manner MN9, it may be performed according to the following steps.

Step B-1: multiplexing and/or prioritizing the PUCCH, for example, according to the methods specified in embodiments of the disclosure and/or the methods specified in 3GPP TS 38.213.

Step B-2: multiplexing and/or prioritizing the PUCCH and/or PUSCH.

In step B-1, a PUCCH transmission with repetitions may be cancelled by a PUCCH transmission without repetitions, which can avoid cancellation of the transmission of the PUSCH and improve the reliability of the PUSCH transmission.

### Manner MN10 (Herein, it May Also be Referred as a Tenth Manner)

In Manner MN10, the multiplexing and/or prioritizing of the PUCCH and/or PUSCH may be based on the following method: in case that a PUSCH overlaps with a PUCCH transmission with repetitions in time domain, the UE does not transmit the PUSCH. For example, the PUSCH may be a repetition of the PUSCH transmission overlapping with the PUCCH transmission with repetitions in time domain. The repetition of the PUSCH transmission may be an actual repetition and/or a nominal repetition.

It should be noted that in Manner MN10, in case that the transmission of the PUSCH is cancelled, the UE will not multiplex a UCI included in a PUCCH (e.g., a PUCCH that is not configured with repetitions) in the PUSCH. That is, when a PUCCH that is not configured with repetitions overlaps with one or more PUSCHs in time domain, the UE first excludes PUSCHs of the one or more PUSCHs that overlap with the PUCCH transmission with repetitions in time domain. Then, the UE selects a PUSCH from the remaining PUSCHs to multiplex the UCI included in the PUCCH. It should be noted that if the one or more PUSCHs all overlap with the PUCCH transmission with repetitions in time domain, the UE transmits the PUCCH.

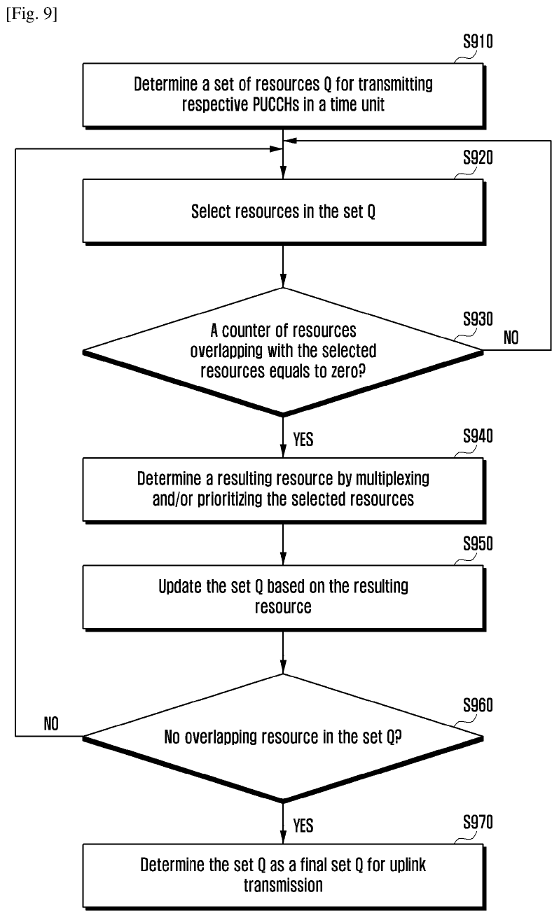

The method can avoid cancellation of the transmission of the UCI. For example, as shown in FIG. 11A, the method can avoid first multiplexing the UCI without repetitions in the PUSCH and then cancelling the PUSCH transmission, which can improve the reliability of the UCI transmission.

### Manner MN11 (Herein, it May Also be Referred as a Eleventh Manner)

In Manner MN11, the UE does not expect that a PUSCH overlaps with a PUCCH that is configured with repetitions and a PUCCH that is not configured with repetitions in time domain simultaneously. The method is simple to implement, can reuse the existing implementation methods, and can reduce the complexity of UE implementation.

In some implementations, the UE is configured with two levels of physical layer priorities, and the UE is configured to be able (e.g., allowed) to multiplex HARQ-ACK with different priorities in a PUCCH and/or PUSCH (for example, the UE is configured with 3GPP parameters pucch-HARQ-ACK-MuxWithDifferentPriority and/or pusch-HARQ-ACK-MuxWithDifferentPriority). In this case, it may be specified by protocols that in case that the PUCCH transmission is configured with repetitions, the UE will not multiplex UCI included in the PUCCH and other different types of UCI(s) and/or data in a PUCCH and/or PUSCH. For example, at least one of the following methods may be adopted:
in case that a PUCCH transmission (e.g., a PUCCH including HARQ-ACK) with repetitions of the lower priority overlaps with a PUCCH and/or PUSCH of the higher priority in time domain, the UE does not transmit the PUCCH transmission with repetitions of the lower priority.
in case that a PUCCH (e.g., a PUCCH including HARQ-ACK) of the lower priority overlaps with a PUCCH transmission with repetitions of the higher priority in time domain, the UE does not transmit the PUCCH of the lower priority. It should be noted that “PUCCH of the lower priority” may be replaced by “PUSCH of the lower priority”.
in case that the UE is configured to support being dynamically indicated whether to multiplex HARQ-ACK and/or data with different priorities (for example, whether to multiplex HARQ-ACK of the lower priority in a PUCCH and/or PUSCH of the higher priority), the UE does not expect to be indicated by a DCI format (e.g., a DCI format of the higher priority) to multiplex the HARQ-ACK of the lower priority with repetitions (e.g., PUCCH transmission with repetitions) in the PUCCH and PUSCH of the higher priority.
in case that the UE is configured to support being dynamically indicated whether to multiplex HARQ-ACK and/or data with different priorities (for example, whether to multiplex HARQ-ACK of the higher priority in the PUCCH and/or PUSCH of the lower priority), the UE does not expect to be indicated by a DCI format (e.g., a DCI format of the higher priority) to multiplex HARQ-ACK of the lower priority with repetitions (e.g., PUCCH transmission with repetitions) in a PUSCH of the lower priority. The UE does not expect to be indicated by a DCI format (e.g., a DCI format of the higher priority) to multiplex the HARQ-ACK of the lower priority in a PUCCH including the HARQ-ACK of the higher priority with repetitions.

The method can ensure the reliability of the PUCCH and/or PUSCH of the higher priority.

It should be noted that if the UE is configured to multiplex HARQ-ACK with different priorities in a PUCCH and/or PUSCH, the PUSCH involved in PUSCH multiplexing and/or prioritization for PUCCHs and/or PUSCHs with different priorities in embodiments of the disclosure may be a PUSCH that does not support simultaneous transmission with a PUCCH (e.g., a PUCCH with a different priority from the PUSCH).

In some implementations, the UE is configured with two levels of physical layer priorities, and the UE is configured to be capable of multiplexing HARQ-ACK with different priorities in a PUCCH and/or PUSCH (for example, the UE is configured with 3GPP parameters pucch-HARQ-ACK-MuxWithDifferentPriority and/or puschHARQ-ACK-MuxWithDifferentPriority). As shown in FIG. 11B, in case that a PUCCH (e.g., a PUCCH including HARQ-ACK of the lower priority) without repetitions overlaps with both a PUCCH (e.g., a PUCCH including HARQ-ACK of the higher priority) without repetitions and a PUCCH of the higher priority (e.g., a PUCCH with SR of the higher priority) with repetitions in time domain, how to determine the multiplexing and/or prioritizing of PUCCHs with different priorities is a problem to be solved, and at least one of the above-mentioned Manners MN1-MN3, MN17, MN18 and the following Manner MN12 may be adopted.

### Manner MN12 (Herein, it May Also be Referred as a Twelfth Manner)

In Manner MN12, in case that a PUCCH (e.g., a PUCCH including HARQ-ACK of the lower priority) without repetitions overlaps with both at least one PUCCH without repetitions (e.g., a PUCCH including HARQ-ACK of the higher priority) and a PUCCH of the higher priority (e.g., a PUCCH with SR of the higher priority) with repetitions in time domain, the HARQ-ACK of the lower priority and the HARQ-ACK and/or SR of the higher priority are multiplexed in a PUCCH of the higher priority. For example, a PUCCH of the lower priority (e.g., a PUCCH including HARQ-ACK of the lower priority) without repetitions may be placed (or associated to) a time unit (or the set Q corresponding to the time unit) of a PUCCH of the higher priority (e.g., a PUCCH including HARQ-ACK of the higher priority) without repetitions.

The method can improve the reliability of transmission of the HARQ-ACK of the lower priority.

In some cases where a PUCCH including HARQ-ACK of the lower priority (e.g., PUCCH without repetitions) overlaps with more than one PUCCH including HARQ-ACK of the higher priority (e.g., PUCCH without repetitions) in time domain, it is necessary to consider how to multiplex and/or prioritize PUCCHs/PUSCHs. In some implementations, when a first predefined condition is satisfied, the HARQ-ACK of the lower priority may be multiplexed with the more than one PUCCH including HARQ-ACK of the higher priority according to a predefined rule, which may include determining at least one of the following from the more than one PUCCH including HARQ-ACK of the higher priority for multiplexing:
the first PUCCH including HARQ-ACK of the higher priority in time sequence;
the first PUCCH including HARQ-ACK of the higher priority in time sequence that can be multiplexed with the HARQ-ACK of the lower priority;
the first PUCCH including HARQ-ACK of the higher priority in time sequence indicated by a DCI format that may be multiplexed with the HARQ-ACK of the lower priority;
the first PUCCH including HARQ-ACK of the higher priority in time sequence that can be multiplexed with the HARQ-ACK of the lower priority and is indicated by a DCI format to be capable of being multiplexed with the HARQ-ACK of the lower priority;
a PUCCH including HARQ-ACK of the higher priority that is indicated by a DCI format to be capable of being multiplexed with the HARQ-ACK of the lower priority.

For example, among the more than one PUCCH including HARQ-ACK of the higher priority, PUCCHs that can be multiplexed with the HARQ-ACK of the lower priority may include at least one of: a PUCCH that is not configured with repetitions; or a PUCCH that is indicated by a DCI format and/or configured by higher layer signaling to be capable of being multiplexed with the PUCCH including HARQ-ACK of the higher priority.

The first predefined condition may include at least one of that:
at least one of the more than one PUCCH including HARQ-ACK of the higher priority can be multiplexed with the HARQ-ACK of the lower priority;
at least one of the more than one PUCCH including HARQ-ACK of the higher priority is a PUCCH indicated by a DCI format;
at least one of the more than one PUCCH including HARQ-ACK of the higher priority is indicated by a DCI format to be capable of being multiplexed with the HARQ-ACK of the lower priority;
there is no PUCCH transmission configured with repetitions;
a predefined timing condition.

If the first predefined condition is not satisfied, the UE does not transmit or cancels the transmission of the PUCCH including HARQ-ACK of the lower priority.

In some implementations, in case that a PUCCH (e.g., PUCCH without repetitions) including HARQ-ACK of the lower priority overlaps with more than one PUCCH (e.g., PUCCH without repetitions) including HARQ-ACK of the higher priority in time domain, when a predefined condition (e.g., the first predefined condition described above) is satisfied, the PUCCH including HARQ-ACK of the lower priority may be placed (e.g., included) into the set Q corresponding to a PUCCH time unit of the higher priority according to a predefined rule, where the set Q is a set of PUCCHs in the PUCCH time unit of the higher priority. Then the PUCCHs in the set Q are multiplexed and/or prioritized. For example, the predefined rule for determining the set Q (or the time unit corresponding to the set Q) may include at least one of:
including the first PUCCH including HARQ-ACK of the higher priority in time sequence to the set Q (or the time unit corresponding to the set Q)
including the first PUCCH including HARQ-ACK of the higher priority in time sequence to the set Q (or the time unit corresponding to the set Q), where the PUCCH transmission is not configured with repetitions
including the first PUCCH including HARQ-ACK of the higher priority in time sequence that can be multiplexed with the HARQ-ACK of the lower priority to the set Q (or the time unit corresponding to the set Q)
including the first PUCCH including HARQ-ACK of the higher priority in time sequence indicated by a DCI format that may be multiplexed with the HARQ-ACK of the lower priority to the set Q (or the time unit corresponding to the set Q)
including the first PUCCH including HARQ-ACK of the higher priority in time sequence that is indicated by a DCI format to be capable of being multiplexed with the HARQ-ACK of the lower priority to the set Q (or the time unit corresponding to the set Q)
including a PUCCH including HARQ-ACK of the higher priority that is indicated by a DCI format to be capable of being multiplexed with the HARQ-ACK of the lower priority to the set Q (or the time unit corresponding to the set Q)

It should be noted that the HARQ-ACK in embodiments of the disclosure may be HARQ-ACK for an SPS PDSCH reception (e.g., HARQ-ACK without DCI indication) and/or HARQ-ACK indicated by a DCI format (e.g., HARQ-ACK for a PDSCH scheduled by the DCI format). However, the embodiments of the disclosure are not limited thereto, and the HARQ-ACK may also be replaced by other types of UCI(s).

The method can improve the reliability of transmission of the UCI of the lower priority, e.g., HARQ-ACK.

In some cases where a PUCCH of the lower priority may overlap with time units (e.g., slots/subslots) of more than one PUCCH of the higher priority in time domain, it is necessary to consider how to multiplex and/or prioritize PUCCHs/PUSCHs. In some implementations, when the first predefined condition is satisfied, the PUCCH of the lower priority may be placed into (e.g., included into/associated to) the set Q corresponding to a PUCCH time unit of the higher priority according to a predefined rule, where the set Q is a set of PUCCHs in the PUCCH time unit of the higher priority. Then the PUCCHs in the set Q are multiplexed and/or prioritized. For example, the method of the predefined rule for determining the set Q (or the time unit corresponding to the set Q) may include at least one of the following Manners MN19˜MN22.

### Manner MN19 (Herein, it May Also be Referred as a Nineteenth Manner)

In Manner MN19, the time unit corresponding to the set Q may be the first (or last) time unit of one or more specific time units (e.g., PUCCH time units) with the higher priority overlapping with the PUCCH with the lower priority in time domain, where the specific time unit of the higher priority is a time unit including at least a PUCCH with HARQ-ACK and/or positive SR of the higher priority.

It should be noted that UCI in the PUCCH with HARQ-ACK of the higher priority and/or positive SR of the higher priority may be at least one of:
a PUCCH with only the HARQ-ACK of the higher priority;
a PUCCH with only the positive SR of the higher priority.
a PUCCH with the HARQ-ACK of the higher priority and the SR of the higher priority, where the SR may be positive SR and/or negative SR.

The method excludes a PUCCH with only negative SR of the higher priority. If the PUCCH of the lower priority is placed in the set Q for a time unit of the higher priority and the time unit of the higher priority include only the PUCCH with only negative SR of the higher priority, the transmission of the PUCCH of the lower priority will not be cancelled at this time; the PUCCH of the lower priority may overlap with PUCCHs of the higher priority in other time units of the higher priority, and the behavior of the UE is undefined at this time. The method can avoid this situation, clarify the behavior of the UE, and improve the reliability of uplink transmission.

### Manner MN20 (Herein, it May Also be Referred as a Twentieth Manner)

In Manner MN20, in case that the PUCCH of the lower priority overlaps with at least one PUCCH with HARQ-ACK of the higher priority in time domain, the set Q (or the time unit corresponding to the set Q) is a set Q (or the time unit corresponding to the set Q) in which the first PUCCH of the at least one PUCCH with HARQ-ACK of the higher priority is located.

In case that the PUCCH of the lower priority does not overlap with the PUCCH with the HARQ-ACK of the higher priority in time domain and the PUCCH of the lower priority overlaps with at least one PUCCH with positive SR of the higher priority in time domain, the set Q (or the time unit corresponding to the set Q) is a set Q (or the time unit corresponding to the set Q) in which the first (or last) PUCCH of the at least one PUCCH with the positive SR of the higher priority is located, or the UE does not transmit the PUCCH of the lower priority (at this time, the UE is not required to determine the set Q or the time unit corresponding to the set Q).

In case that the PUCCH of the lower priority does not overlap with the PUCCH of the higher priority in time domain, the UE transmits the PUCCH of the lower priority.

The method excludes the PUCCH with only negative SR of the higher priority, clarifies the behavior of the UE, and thus can improve the reliability of uplink transmission. The method can reduce the probability that the transmission of the HARQ-ACK of the lower priority is cancelled, and can improve the reliability of the transmission of the HARQ-ACK of the lower priority.

### Manner MN21 (Herein, it May Also be Referred as a Twenty-First Manner)

In Manner MN21, in case that the PUCCH of the lower priority overlaps with at least one PUCCH with HARQ-ACK of the higher priority without repetitions in time domain, the set Q (or the time unit corresponding to the set Q) is a set Q (or the time unit corresponding to the set Q) in which the first (or last) PUCCH of the at least one PUCCH with HARQ-ACK of the higher priority without repetitions is located.

In case that the PUCCH of the lower priority does not overlap with the PUCCH with HARQ-ACK of the higher priority without repetitions in time domain and the PUCCH of the lower priority overlaps with at least one PUCCH with positive SR of the higher priority and/or a PUCCH transmission with HARQ-ACK of the higher priority with repetitions in time domain, the set Q (or the time unit corresponding to the set Q) is a set Q (or the time unit corresponding to the set Q) in which the first (or last) PUCCH of the at least one PUCCH with the positive SR of the higher priority and/or the PUCCH transmission with the HARQ-ACK of the higher priority with repetitions is located, or the UE does not transmit the PUCCH of the lower priority (at this time, the UE is not required to determine the set Q or the time unit corresponding to the set Q).

In case that the PUCCH of the lower priority does not overlap with the PUCCH of the higher priority in time domain, the UE transmits the PUCCH of the lower priority.

The method can reduce the probability that the transmission of the HARQ-ACK of the lower priority is cancelled, and can improve the reliability of the transmission of the HARQ-ACK of the lower priority.

It should be noted that in embodiments of the disclosure, “a PUCCH with HARQ-ACK of the higher priority” may be replaced by “a first specific format (for example, the first specific format may be format 0 and/or format 1) of the PUCCH with the HARQ-ACK of the higher priority and/or a PUCCH with positive SR of the higher priority”, and/or “a PUCCH with positive SR of the higher priority” may be replaced by “a second specific format (for example, the second specific format may be format 2 and/or format 3 and/or format 4) of the PUCCH with the positive SR of the higher priority”.

### Manner MN22 (Herein, it May Also be Referred as a Twenty-Second Manner)

In Manner MN22, in case that a PUCCH including only CSI and/or SR of the lower priority does not overlap with a PUCCH of the higher priority (e.g., a PUCCH with HARQ-ACK and/or positive SR of the higher priority) in time domain, and a PUCCH including HARQ-ACK of the lower priority in a time unit of the lower priority where the PUCCH with only CSI and/or SR of the lower priority is located overlaps with the PUCCH of the higher priority (e.g., the PUCCH with the HARQ-ACK and/or the positive SR including the higher priority) in time domain, a set Q of the higher priority (or a time unit of the higher priority corresponding to the set Q) associated with the PUCCH with only the CSI and/or SR of the lower priority is a set Q of the higher priority (or a time unit of the higher priority corresponding to the set Q) associated with the PUCCH with the HARQ-ACK of the lower priority. For example, the set Q of the higher priority (or the time unit of the higher priority corresponding to the set Q) associated with the PUCCH with the HARQ-ACK of the lower priority is determined according to other embodiments of the disclosure.

The method can solve the problem that the PUCCH after the HARQ-ACK of the lower priority is multiplexed with the HARQ-ACK of the higher priority overlaps with the PUCCH with only CSI and/or SR of the lower priority in time domain, and can improve the reliability of uplink transmission.

In some cases, if a PUCCH with HARQ-ACK of the lower priority overlaps with a PUCCH with positive SR of the higher priority in time domain, the UE may not be capable of multiplexing the HARQ-ACK of the lower priority and the positive SR of the higher priority in a PUCCH for transmission. At this time, the UE will not transmit the HARQ-ACK of the lower priority. In order to avoid cancellation of the transmission of the HARQ-ACK of the lower priority, it may be specified by protocols that the UE does not expect that a PUCCH of a first specific format with HARQ-ACK of the lower priority overlaps with a PUCCH with positive SR of the higher priority in time domain. The method can reduce the complexity of UE implementation.

In some implementations, HARQ-ACK for an SPS PDSCH reception may be configured with deferral. For a given HARQ process, in case that the UE expects, before the end of the HARQ-ACK transmission for a PDSCH reception of the HARQ process (for example, expected transmission of the HARQ-ACK; for another example, actual transmission of the HARQ-ACK), to receive another PDSCH of the HARQ process, and that a priority of the HARQ-ACK for the PDSCH reception is the same as that of the HARQ-ACK for the SPS PDSCH reception, the UE does not transmit the HARQ-ACK information for the previous SPS PDSCH reception. In case that the priority of the HARQ-ACK for the PDSCH reception is different from that of the HARQ-ACK for the SPS PDSCH reception and/or the UE is not configured to multiplex HARQ-ACK with different priorities in the PUCCH, the UE does not transmit HARQ-ACK information of the lower priority. In case that the priority of the HARQ-ACK for the PDSCH reception is different from that of the HARQ-ACK for the SPS PDSCH reception and/or the UE is configured to multiplex HARQ-ACK with different priorities in the PUCCH, the UE does not transmit the HARQ-ACK information for the previous SPS PDSCH reception. When a PUCCH transmission with the HARQ-ACK for the SPS PDSCH reception is configured with repetitions, if UCI information of the transmission with repetitions is different, each repetition transmission cannot be combined for decoding.

For a given HARQ process, in case that a PUCCH transmission with HARQ-ACK for a PDSCH reception of the HARQ process is configured with repetitions, and the UE expects, before the end of the PUCCH transmission, to receive another PDSCH of the HARQ process (for example, a priority of the HARQ-ACK for the PDSCH reception is the same as and/or different from that of the HARQ-ACK for the SPS PDSCH reception), at least one of Manners MN13-MN15 may be adopted.

### MN13 (Herein, it May Also be Referred as a Thirteenth Manner)

In Manner MN13, the UE does not transmit (or stops transmitting) repetitions of the PUCCH transmission.

### Manner MN14 (Herein, it May Also be Referred as a Fourteenth Manner)

In Manner MN14, in case that another PDSCH of the HARQ process is expected to be received before the first repetition of the PUCCH transmission, the UE does not transmit the HARQ-ACK for the SPS PDSCH reception.

### Manner MN15 (Herein, it May Also be Referred as a Fifteenth Manner)

In Manner MN15, the UE transmits (or stops transmitting) the remaining repetition transmissions of the PUCCH.

The method clarifies the processing of the conflict of the same HARQ process by the UE, and can improve the reliability of uplink transmission.

In some implementations, the UE may be configured by higher layer signaling to multiplex HARQ-ACK and/or data with different priorities, which may be configured for example by 3GPP parameter pucch-HARQ-ACK-MuxWithDifferentPriority or pusch-HARQ-ACK-MuxWithDifferentPriority. Manner MN16 may be adopted to determine the multiplexing and/or prioritization of uplink channels.

### Manner MN16 (Herein, it May Also be Referred as a Sixteenth Manner)

In Manner MN16, the UE first resolves multiplexing of a PUCCH and/or PUSCH of the lower priority (for example, according to the methods specified in 3GPP TS38.213 9.2.5 and 9.2.6). Then, in case that the UE is configured by higher layer signaling to multiplex HARQ-ACK and/or data with different priorities, for example, the UE is configured with 3GPP parameter pucch-HARQ-ACK-MuxWithDifferentPriority or pusch-HARQ-ACK-MuxWithDifferentPriority, optionally, the UE multiplexes PUCCHs and/or PUSCHs with different priorities. For example, the UE may perform the processes in 3GPP TS38.213 9.2.5.3 or 9.3 respectively. For example, Manner MN16 may include at least one of the following steps.

First, the UE first resolves overlapping for PUCCHs and/or PUSCHs of the higher priority (for example, according to the methods specified in 3GPP TS38.213 9.2.5 and 9.2.6).

Second, the UE first resolves the overlapping for PUCCHs with different priorities.

Third, the UE resolves the overlapping for PUCCHs and/or PUSCHs with different priorities.

For example, in case that the timing condition for multiplexing UCI in a PUCCH and/or PUSCH specified in 3GPP TS 38.213 9.2.5 is satisfied, and optionally, when the UE cannot transmit a PUCCH and a PUSCH simultaneously, or the UE can transmit the PUCCH and PUSCH simultaneously and the UE does not multiplex UCI in the PUSCH:
if
a PUCCH transmission with HARQ-ACK, without repetitions, of the lower priority overlaps with a PUCCH transmission with HARQ-ACK, without repetitions, of the higher priority (for example, in time domain)
a PUCCH transmission with HARQ-ACK, without repetitions, of the lower priority overlaps with a PUSCH transmission of the higher priority (for example, in time domain)
a PUCCH transmission with HARQ-ACK, without repetitions, of the higher priority overlaps with a PUSCH transmission of the lower priority (for example, in time domain)

The UE multiplexes HARQ-ACK (for example, HARQ-ACK with different priorities) in a PUCCH or PUSCH transmission, and optionally, the UE performs the processes in 3GPP TS38.213 9.2.5.3 or 9.3 respectively.
else
if the UE would transmit at least one of the following channels (including repetitions) that overlap in time domain
a first PUCCH of the higher priority and a second PUCCH of the lower priority
a first PUCCH of the higher priority and a second PUSCH of the lower priority, optionally, where the UE cannot transmit the first PUCCH and the second PUSCH simultaneously
a first PUCCH of the lower priority and a second PUSCH of the higher priority, optionally, where the UE cannot transmit the first PUCCH and the second PUSCH simultaneously
a first PUSCH of the higher priority and a second PUSCH of the lower priority on a same serving cell
then the UE
transmits the PUCCH or PUSCH of the higher priority, and
if the UE does not indicate a capability to support being dynamically indicated to multiplex of UCI in a PUCCH or PUSCH with different priorities through a DCI format, the PUCCH or PUSCH of the lower priority is not transmitted.

The method clarifies the behavior of the UE, and can improve the reliability of uplink transmission and network performance.

It should be noted that in embodiments of the disclosure, “lower priority” may be used interchangeably with “smaller priority index”, and “higher priority” may be used interchangeably with “larger priority index”.

In some embodiments, the UE may be configured by higher layer signaling to multiplex UCI and/or data with different priorities, for example, by the 3GPP parameter UCI-MuxWithDifferentPriority. Manner MN23 may be adopted to determine the multiplexing and/or prioritization of uplink channels that overlap.

### Mode MN23 (Herein, it May Also be Referred to as Twenty-Third Manner)

In Manner MN23, the UE first resolves overlapping for PUCCH transmissions and/or PUSCH transmissions of smaller priority index (for example, multiplexing and/or prioritizing according to the methods specified in 3GPP TS38.213 9.2.5 and 9.2.6). Then, if the UE is configured by higher layer signaling to multiplex UCI(s) and/or data with different priorities, which may be configured for example by 3GPP parameter UCI-MuxWithDifferentPriority, Manner MN23 may include at least one of the following steps.
first, the UE resolves overlapping for PUCCH transmissions and/or PUSCH transmissions of larger priority index (for example, multiplexing and/or prioritizing according to the methods specified in 3GPP TS38.213 9.2.5 and 9.2.6).
second, the UE resolves the overlapping for PUCCH transmissions of different priority indexes.
if the UE is configured with a subslot length parameter (e.g., 3GPP parameter subslotLengthForPUCCH) in the second PUCCH configuration (e.g., second 3GPP parameter PUCCH-Config), the PUCCH transmissions of smaller priority index are associated to the first overlapping slot of larger priority index (for example, the slot consists of subslotLengthForPUCCH symbols); otherwise, the PUCCH transmissions of smaller priority index are associated to the overlapping slot of larger priority index (e.g., the slot consists of N_{sym}^{slot} symbols, where N_{sym}^{slot} is equal to 14 for normal CP (cyclic prefix) and N_{sym}^{slot} is equal to 12 for extended CP).
the UE first resolves the overlapping for PUCCH transmissions in the slot of larger priority index, where at least one of the PUCCH transmissions is with N_{PUCCH}^{repeat}>1 repetitions (if present), then the UE resolves the overlapping for PUCCH transmissions without repetitions in the slot. For example, the UE makes the determination according to the pseudo code in TS 38.213 9.2.5. For another example, the UE makes the determination according to the pseudo code in embodiments of the disclosure.
if, in an overlapping slot, the UE determines that a first PUCCH transmission of smaller priority index is not discarded, and/or UCI(s) carried by the first PUCCH transmission is not multiplexed in a second PUCCH transmission of larger priority index, the first PUCCH transmission is associated to the next overlapping slot for the PUCCH transmissions of larger priority index.
the UE does not expect that a PUCCH transmission with UCI(s) of different priority indexes overlaps with the PUCCH transmission with N_{PUCCH}^{repeat}>1 repetitions after resolving the overlapping PUCCH transmissions without repetitions in a slot.
the UE does not expect that a PUCCH transmission for UCI(s) of first and second priority indexes overlaps with a PUCCH transmissions or PUSCH transmission of the second priority index, where the second priority index is larger than the first priority index.
the UE does not expect that a PUCCH transmission with HARQ-ACK of larger priority index overlaps with multiple PUCCH transmissions with HARQ-ACK of smaller priority index.

Step 3, the UE resolves the overlapping for PUCCH transmissions and/or PUSCH transmissions of different priority indexes.
the UE discards a PUSCH transmission of smaller priority index that overlaps with a PUCCH transmission with positive SR of larger priority index, before multiplexing UCI(s) in PUSCH transmissions of smaller priority index (if present).
the UE discards a PUSCH transmissions of smaller priority index that overlaps with a PUCCH transmission of larger priority index with N_{PUCCH}^{repeat}>1 repetitions, before multiplexing UCI(s) in PUSCH transmissions of smaller priority index (if present).
if a PUCCH transmission with HARQ-ACK information of a first priority index overlaps with one or more PUSCH transmissions of a second priority index that is different from the first priority index, the UE multiplexes HARQ-ACK information carried by the PUCCH transmission in a PUSCH according to a method of multiplexing HARQ-ACK information carried by a PUCCH in a PUSCH of the same priority index (e.g., the methods specified in 3GPP TS 38.213 9).
if
a PUCCH transmission with HARQ-ACK, without repetitions, of smaller priority index overlaps with a PUCCH transmission with HARQ-ACK (e.g., HARQ-ACK only), without repetitions, of larger priority index (for example, in time domain), or
a PUCCH transmission with HARQ-ACK, without repetitions, of smaller priority index overlaps with a PUCCH transmission with HARQ-ACK and SR, without repetitions, of larger priority index (for example, in time domain), where the PUCCH transmission uses PUCCH format 2/3/4, or
a PUCCH transmission of smaller priority index but without repetitions that carries HARQ-ACK overlaps with a PUSCH transmission of larger priority index (for example, in time domain)
a PUCCH transmission of larger priority index but without repetitions that carries HARQ-ACK overlaps with a PUSCH transmission of smaller priority index (for example, in time domain)
the UE multiplexes HARQ-ACK information of different priority indexes and SR information of larger priority index (if present) in a PUCCH transmission of larger priority index, or the UE multiplexes HARQ-ACK information of smaller priority index or larger priority index in a PUSCH transmission of larger priority index or smaller priority index, respectively, and the UE performs the procedures in 3GPP TS38.213 9.2.5.3 or 9.3, respectively. Also,
the UE discards CSI(s) and/or SR (if present) carried by a PUCCH of smaller priority index
else
if the UE would transmit the following channels that overlap in time domain, if a channel transmission is with repetitions, the following are applicable per repetition
a first PUCCH transmission of larger priority index and a second PUCCH transmission of smaller priority index.
a PUCCH transmission of larger priority index and a PUSCH transmission of smaller priority index, where the UE cannot transmit the PUCCH and the PUSCH simultaneously
a PUCCH transmission of smaller priority index and a PUSCH transmission of larger priority index, where the UE cannot transmit the PUCCH and the PUSCH simultaneously
then the UE
transmits a PUCCH or a PUSCH of larger priority index, and
does not transmit a PUCCH or a PUSCH of smaller priority index.

It should be noted that “the UE first resolves overlapping for PUCCH transmissions and/or PUSCH transmissions of smaller priority index, and then UE resolves the overlapping for PUCCH transmissions and/or PUSCH transmissions of larger priority index” may be replaced by “UE resolves overlapping for PUCCH transmissions and/or PUSCH transmissions of a same priority index”.

The method clarifies the behavior of the UE, and can improve the reliability of uplink transmission and network performance.

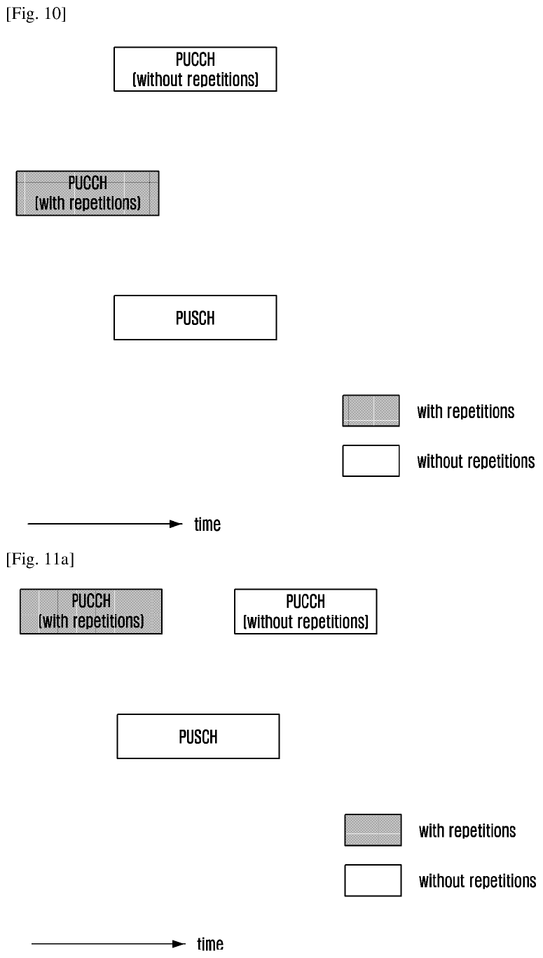

FIG. 12 illustrates a flowchart of a method performed by a terminal according to some embodiments of the disclosure.

Referring to FIG. 12, in operation S1210, a downlink signal including at least one of downlink data or DCI is received.

Next, in operation S1220, uplink signals to be transmitted is determined based on the downlink signal, and at least one of a time unit or an uplink channel for transmitting the uplink signal is determined, where the uplink signal includes at least one of uplink data or uplink control information (UCI), and the uplink channel includes at least one of a physical uplink control channel (PUCCH) or a physical uplink shared channel (PUSCH).

Then, in operation S1230, an uplink transmission is performed based on the determined uplink signals, and the determined time units and/or uplink channels.

For example, the method may include methods or operations that may be performed by the terminal in various embodiments described above.

For example, in some implementations, the performing of the uplink transmission based on the determined uplink signals, and the determined time units or uplink channels includes performing multiplexing and/or prioritization of the determined uplink channels.

For example, in some implementations, the performing of the multiplexing and/or prioritization of the uplink channels includes at least one of: multiplexing and/or prioritizing PUCCHs that are not configured with repetitions in a time unit; multiplexing and/or prioritizing all PUCCHs in the time unit; or selecting a predetermined number of PUCCHs from all PUCCHs in the time unit, and multiplexing and/or prioritizing the selected PUCCHs.

For example, in some implementations, when the determined uplink channels include a first PUCCH that is configured with repetitions and a second PUCCH that is not configured with repetitions, the terminal does not expect that the first PUCCH overlaps with the second PUCCH in time domain and the second PUCCH overlaps with another PUCCH in time domain; and/or when the determined uplink channels include the second PUCCH and multiple third PUCCHs, the terminal does not expect the second PUCCH overlaps with the multiple third PUCCHs in time domain, where at least one of the multiple third PUCCHs is configured with repetitions; and/or when the determined uplink channels include the first PUCCH and multiple fourth PUCCHs, the terminal does not expect that the first PUCCH overlaps with the multiple fourth PUCCHs in time domain.

For example, in some implementations, the performing of the multiplexing and/or prioritization of the determined uplink channels includes, when the determined uplink channels include a fifth PUCCH and a sixth PUCCH that are configured with repetitions, the sixth PUCCH including multiple UCIs, determining an ordering priority of each UCI of the multiple UCIs, and determining an ordering priority of the sixth PUCCH based on at least one of the following and performing the multiplexing and/or prioritization based on the determined ordering priority: UCI with a highest ordering priority among the multiple UCIs; or UCI with a lowest ordering priority among the multiple UCIs. Each of the multiple UCIs may include HARQ-ACK information, SR or CSI.

For example, in some implementations, when the determined uplink channels include a seventh PUCCH that is configured with repetitions and an eighth PUCCH and/or PUSCH that is not configured with repetitions, and the seventh PUCCH overlaps with the eighth PUCCH and/or PUSCH in time domain, the performing of the multiplexing and/or prioritization of the determined uplink channels includes: performing the multiplexing and/or prioritization of the seventh PUCCH and the eighth PUCCH to obtain the multiplexed and/or prioritized PUCCH; or performing the multiplexing and/or prioritization of the multiplexed and/or prioritized PUCCH and/or PUSCH.

For example, in some implementations, the terminal does not expect that the PUSCH overlaps with both a PUCCH that is configured with repetitions and a PUCCH that is not configured with repetitions in time domain.

For example, in some implementations, when the terminal is configured to multiplex UCIs with different priorities in the PUCCH and/or PUSCH, in case that the determined uplink channels include a ninth PUCCH and the ninth PUCCH is configured with repetitions, the terminal does not multiplex UCI included in the ninth PUCCH and other different types of UCIs and/or uplink data in the PUCCH and/or PUSCH.

For example, in some implementations, in case that the ninth PUCCH is of a second priority and the ninth PUCCH overlaps with a PUCCH and/or PUSCH of a first priority in time domain, the terminal does not transmit the ninth PUCCH, where the first priority is different from (for example, greater than) the second priority; and/or in case that the ninth PUCCH is of the second priority and the ninth PUCCH overlaps with another PUCCH of the first priority that is configured with repetitions in time domain, the terminal does not transmit the ninth PUCCH.

For example, in some implementations, in case that the terminal is configured to support being dynamically indicated whether to multiplex UCIs and/or uplink data with different priorities, the terminal does not expect to be indicated by a DCI format to multiplex a UCI of a second priority with repetitions in a PUCCH and/or PUSCH of a first priority, where the first priority is different from (for example, greater than) the second priority; and/or in case that the terminal is configured to support being dynamically indicated whether to multiplex UCIs and/or uplink data with different priorities, the terminal does not expect to be indicated by a DCI format to multiplex a UCI of the first priority with repetitions in a PUSCH of the second priority; and/or in case that the terminal is configured to support being dynamically indicated whether to multiplex UCIs and/or uplink data with different priorities, the terminal does not expect to be indicated by a DCI format to multiplex UCI of the second priority in a PUCCH with a UCI of the first priority that is configured with repetitions.

For example, in some implementations, the performing of the multiplexing and/or prioritization of the determined uplink channels includes, when the determined uplink channels include a tenth PUCCH with a UCI of a second priority and more than one eleventh PUCCH with a UCI of a first priority, and the tenth PUCCH overlaps with at least one of the more than one eleventh PUCCH in time domain, multiplexing the UCI of the second priority, which is different from (for example, greater than) the second priority, and the more than one eleventh PUCCH based on at least one of the following in case that a predefined condition is satisfied:
the first eleventh PUCCH in time sequence among the more than one eleventh PUCCH;
the first eleventh PUCCH in time sequence that is capable of being multiplexed with the UCI of the second priority among the more than one eleventh PUCCH;
the first eleventh PUCCH in time sequence indicated by a DCI format, which is capable of being multiplexed with the UCI of the second priority, among the more than one eleventh PUCCH; or
the first eleventh PUCCH in time sequence that is indicated by a DCI format to be capable of being multiplexed with the UCI of the second priority among the more than one eleventh PUCCH; or
an eleventh PUCCH that is indicated by a DCI format to be capable of being multiplexed with the UCI of the second priority among the more than one eleventh PUCCH.

For example, in some implementations, the performing of the multiplexing and/or prioritization of the determined uplink channels includes, when the determined uplink channels include a tenth PUCCH with a UCI (e.g., HARQ-ACK information) of a second priority and more than one eleventh PUCCH with a UCI (e.g., HARQ-ACK information), of a first priority, which is different from (for example, greater than) the second priority, and the tenth PUCCH overlaps with at least one of the more than one eleventh PUCCH in time domain: updating a set of resources in a time unit of the first priority in case that a predefined condition is satisfied; and performing the multiplexing and/or prioritization based on the updated set.

For example, in some implementations, the updated set includes at least one of:
a set including the first eleventh PUCCH in time sequence among the more than one eleventh PUCCH;
a set including the first eleventh PUCCH in time sequence that is capable of being multiplexed with the UCI of the second priority among the more than one eleventh PUCCH;
a set including the first eleventh PUCCH in time sequence indicated by a DCI format, which is capable of being multiplexed with the UCI of the second priority;
a set including the first eleventh PUCCH in time sequence that is indicated by a DCI format to be capable of being multiplexed with the UCI of the second priority among the more than one eleventh PUCCH; or
a set including an eleventh PUCCH that is indicated by a DCI format to be capable of being multiplexed with the UCI of the second priority among the more than one eleventh PUCCH.

For example, in some implementations, the predefined condition includes at least one of that:
at least one of the more than one eleventh PUCCH is capable of being multiplexed with the UCI of the second priority;
at least one of the more than one eleventh PUCCH is a PUCCH indicated by a DCI format;
at least one of the more than one eleventh PUCCH is indicated by a DCI format to be capable of being multiplexed with the UCI of the second priority;
there is no PUCCH that is configured with repetitions; or
a predefined timing condition.

In some implementations, the UE may be configured with a PUCCH subslot length parameter (e.g., the 3GPP parameter subslotLengthForPUCCH) and a PUCCH transmission with repetitions (for example, a number of the repetitions of the PUCCH transmission N_{PUCCH}^{repeat}>1) At this time, the UE performs the PUCCH transmission with repetitions based on subslots, and it is necessary to determine the start subslot for the PUCCH transmission with repetitions and a start symbol in each subslot.

A method is that the determination is based on a start symbol parameter (e.g., the 3GPP parameter startingSymbolIndex) configured in a PUCCH resource and the PUCCH subslot length parameter. For example, a start subslot in a slot is a subslot in which the start symbol parameter is located (for example, the start subslot is └startingSymbolIndex/subslotLengthForPUCCH┘, where └ ┘ represents rounding down), and the start symbol in each subslot may be mod(startingSymbolIndex, subslotLengthForPUCCH), where “mod” represents a modulus operation.

For example, the PUCCH transmission in each time unit of N_{PUCCH}^{repeat}>time units (the time units may be slots or subslots) has a same first symbol. If the PUCCH subslot length parameter (e.g., parameter subslotLengthForPUCCH in 3GPP) is not configured, the first symbol is the PUCCH start symbol parameter (e.g., 3GPP parameter startingSymbolIndex), otherwise, the first symbol is mod(startingSymbolIndex, subslotLengthForPUCCH).

The method gives a method of determining the start subslots and the first symbol in each subslot when the PUCCH is repeatedly transmitted, which clarifies the behavior of the UE and can improve the reliability of PUCCH transmission.

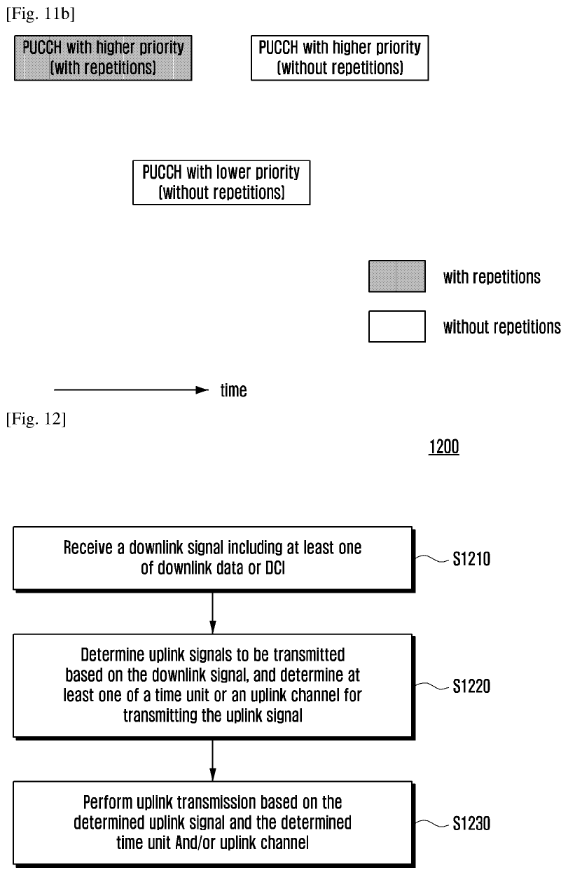

FIG. 13 illustrates a block diagram of a first transceiving node 1300 according to some embodiments of the disclosure.

Referring to FIG. 13, the first transceiving node 1300 may include a transceiver 1301 and a controller 1302.

The transceiver 1301 may be configured to transmit first data and/or first control signaling to a second transceiving node and receive second data and/or second control signaling from the second transceiving node in a time unit.

The controller 1302 may be an application specific integrated circuit or at least one processor. The controller 1302 may be configured to control the overall operation of the first transceiving node, including controlling the transceiver 1301 to transmit the first data and/or the first control signaling to the second transceiving node and receive the second data and/or the second control signaling from the second transceiving node in a time unit.

In some implementations, the controller 1302 may be configured to perform one or more of operations in the methods of various embodiments described above.

Herein, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

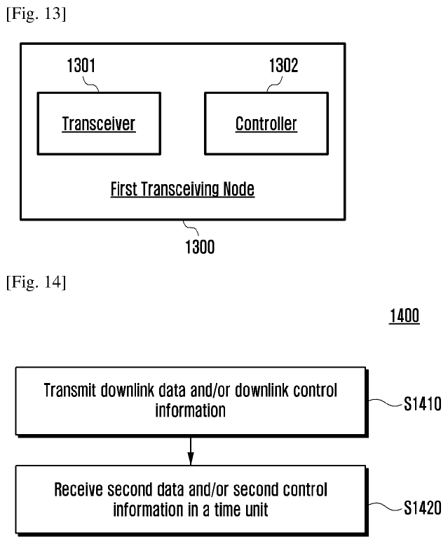

FIG. 14 illustrates a flowchart of a method 1400 performed by a base station according to some embodiments of the disclosure.

Referring to FIG. 14, in step S1410, the base station transmits downlink data and/or downlink control information.

In step S1420, the base station receives second data and/or second control information from a terminal in a time unit.

For example, the method 1400 may include one or more of the operations performed by the base station described in various embodiments of the disclosure.

In some implementations, the downlink channel may include a PDCCH and/or a PDSCH. The uplink channel may include a PUCCH and/or a PUSCH.

Those skilled in the art will understand that the above illustrative embodiments are described herein and are not intended to be limiting. It should be understood that any two or more of the embodiments disclosed herein may be combined in any way. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

According to embodiments of the disclosure, at least a part of an apparatus (e.g., a module or a function thereof) or a method (e.g., an operation or a step) may be implemented as, for example, instructions stored in a computer readable storage medium (e.g., a memory) in a form of a program module. When executed by a processor or controller, the instructions may enable the processor or controller to perform corresponding functions. A computer readable medium may include, for example, hard disk, floppy disk, magnetic medium, optical recording medium, DVD, magneto-optical medium. The instructions may include code created by a compiler or code executable by an interpreter. The module or apparatus according to various embodiments of the disclosure may include at least one or more of the above components, some of which may be omitted, or other additional components may also be included. Operations performed by modules, programming modules or other components according to various embodiments of the disclosure may be performed sequentially, in parallel, repeatedly or heuristically, or at least some operations may be performed in a different order or omitted, or other operations may be added.

The above description is only exemplary implementations of the present invention, and is not intended to limit the scope of protection of the present invention, which is determined by the appended claims.

1. A method for uplink transmission performed by a terminal in a wireless communication system, comprising:
receiving a downlink signal including at least one of downlink data or downlink control information (DCI); and
determining uplink signals to be transmitted based on the downlink signal, and determining at least one of a time unit or an uplink channel for transmitting the uplink signal, wherein the uplink signal includes at least one of uplink data or uplink control information (UCI), and the uplink channel includes at least one of a physical uplink control channel (PUCCH) or a physical uplink shared channel (PUSCH); and
performing an uplink transmission based on the determined uplink signals, and the determined time units and/or uplink channels.

2. The method of claim 1, wherein the performing of the uplink transmission based on the determined uplink signal, and the determined time units and/or uplink channels comprises performing multiplexing and/or prioritization of the determined uplink channels.

3. The method of claim 2, wherein the performing of the multiplexing and/or prioritization of the uplink channels comprises at least one of:
multiplexing and/or prioritizing PUCCHs that are not configured with repetitions in a time unit;
multiplexing and/or prioritizing all PUCCHs in the time unit; or
selecting a predetermined number of PUCCHs from all PUCCHs in the time unit, and multiplexing and/or prioritizing the selected PUCCHs.

4. The method of claim 2, wherein:
when the determined uplink channels include a first PUCCH that is configured with repetitions and a second PUCCH that is not configured with repetitions, the terminal does not expect that the first PUCCH overlaps with the second PUCCH in time domain and the second PUCCH overlaps with another PUCCH in time domain; and/or
when the determined uplink channels include the second PUCCH and multiple third PUCCHs, the terminal does not expect that the second PUCCH overlaps with the multiple third PUCCHs in time domain, wherein at least one of the multiple third PUCCHs is configured with repetitions; and/or
when the determined uplink channels include the first PUCCH and multiple fourth PUCCHs, the terminal does not expect that the first PUCCH overlaps with the multiple fourth PUCCHs in time domain.

5. The method of claim 2, wherein the performing of the multiplexing and/or prioritization of the determined uplink channels comprises, when the determined uplink channels include a fifth PUCCH and a sixth PUCCH that are configured with repetitions, wherein the sixth PUCCH includes multiple UCIs, determining an ordering priority of each UCI of the multiple UCIs, and determining an ordering priority of the sixth PUCCH based on at least one of the following and performing the multiplexing and/or prioritization based on the determined ordering priority:
a UCI with a highest ordering priority among the multiple UCIs; or
a UCI with a lowest ordering priority among the multiple UCIs.

6. The method of claim 2, wherein, when the determined uplink channels include a seventh PUCCH that is configured with repetitions and an eighth PUCCH and/or PUSCH that is not configured with repetitions, and the seventh PUCCH overlaps with the eighth PUCCH and/or PUSCH in time domain, the performing of the multiplexing and/or prioritization of the determined uplink channels comprises:
multiplexing and/or prioritizing of the seventh PUCCH and the eighth PUCCH to obtain the multiplexed and/or prioritized PUCCH; or
multiplexing and/or prioritizing the multiplexed and/or prioritized PUCCH and/or PUSCH.

7. The method of claim 2, wherein the terminal does not expect that the PUSCH overlaps with both a PUCCH that is configured with repetitions and a PUCCH that is not configured with repetitions in time domain.

8. The method of claim 2, wherein, when the terminal is configured to multiplex UCIs with different priorities in a PUCCH and/or a PUSCH, in case that the determined uplink channels include a ninth PUCCH and the ninth PUCCH is configured with repetitions, the terminal does not multiplex a UCI included in the ninth PUCCH and other different types of UCIs and/or uplink data in the PUCCH and/or PUSCH.

9. The method of claim 8, wherein:
in case that the ninth PUCCH is of a second priority and the ninth PUCCH overlaps with a PUCCH and/or PUSCH of a first priority in time domain, the terminal does not transmit the ninth PUCCH, wherein the first priority is different from the second priority; and/or
in case that the ninth PUCCH is of the second priority and the ninth PUCCH overlaps with another PUCCH of the first priority that is configured with repetitions in time domain, the terminal does not transmit the ninth PUCCH.

10. The method of claim 8, wherein:
in case that the terminal is configured to support being dynamically indicated whether to multiplex UCIs and/or uplink data with different priorities, the terminal does not expect to be indicated by a DCI format to multiplex a UCI of a second priority with repetitions in a PUCCH and/or PUSCH of a first priority, wherein the first priority is different from the second priority;
and/or in case that the terminal is configured to support being dynamically indicated whether to multiplex UCIs and/or uplink data with different priorities, the terminal does not expect to be indicated by a DCI format to multiplex a UCI of the first priority with repetitions in a PUSCH of the second priority; and/or
in case that the terminal is configured to support being dynamically indicated whether to multiplex UCIs and/or uplink data with different priorities, the terminal does not expect to be indicated by a DCI format to multiplex a UCI of the second priority in a PUCCH configured with repetitions that carries a UCI of the first priority.

11. The method of claim 2, wherein the performing of the multiplexing and/or prioritization of the determined uplink channels comprises, when the determined uplink channels include a tenth PUCCH with a UCI of a second priority and more than one eleventh PUCCH with a UCI of a first priority, and the tenth PUCCH overlaps with at least one of the more than one eleventh PUCCH in time domain, in case that a predefined condition is satisfied, multiplexing the UCI of the second priority, that is different from the second priority, and the more than one eleventh PUCCH based on at least one of:
the first eleventh PUCCH in time sequence among the more than one eleventh PUCCH;
the first eleventh PUCCH in time sequence that is capable of being multiplexed with the UCI of the second priority among the more than one eleventh PUCCH;
the first eleventh PUCCH in time sequence indicated by a DCI format that is capable of being multiplexed with the UCI of the second priority among the more than one eleventh PUCCH; or
the first eleventh PUCCH in time sequence that is indicated by a DCI format to be capable of being multiplexed with the UCI of the second priority among the more than one eleventh PUCCH; or
an eleventh PUCCH that is indicated by a DCI format to be capable of being multiplexed with the UCI of the second priority among the more than one eleventh PUCCH.

12. The method of claim 2, wherein the performing of the multiplexing and/or prioritization of the determined uplink channels comprises, when the determined uplink channels include a tenth PUCCH with a UCI of a second priority and more than one eleventh PUCCH with a UCI of a first priority, and the tenth PUCCH overlaps with at least one of the more than one eleventh PUCCH in time domain, wherein the first priority is different from the second priority:
updating a set of resources in a time unit of the first priority in case that a predefined condition is satisfied; and
performing the multiplexing and/or prioritization based on the updated set.

13. The method of claim 12, wherein the updated set includes at least one of:
a set including the first eleventh PUCCH in time sequence among the more than one eleventh PUCCH;
a set including the first eleventh PUCCH in time sequence that is capable of being multiplexed with the UCI of the second priority among the more than one eleventh PUCCH;
a set including the first eleventh PUCCH in time sequence indicated by a DCI format that is capable of being multiplexed with the UCI of the second priority;
a set including the first eleventh PUCCH in time sequence that is indicated by a DCI format to be capable of being multiplexed with the UCI of the second priority among the more than one eleventh PUCCH;
a set including an eleventh PUCCH that is indicated by a DCI format to be capable of being multiplexed with the UCI of the second priority among the more than one eleventh PUCCH.

14. The method of claim 12, wherein the predefined condition includes at least one of that:
at least one of the more than one eleventh PUCCH is capable of being multiplexed with the UCI of the second priority;
at least one of the more than one eleventh PUCCH is a PUCCH indicated by a DCI format;
at least one of the more than one eleventh PUCCH is indicated by a DCI format to be capable of being multiplexed with the UCI of the second priority;
there is no PUCCH configured with repetitions; or
a predefined timing condition.

15. A terminal in a wireless communication system, including:
a transceiver configured to transmit and receive signals; and
a controller coupled with the transceiver and configured to:
receive a downlink signal including at least one of downlink data or downlink control information (DCI),
determine uplink signals to be transmitted based on the downlink signal,
determine at least one of a time unit or an uplink channel for transmitting the uplink signal, wherein the uplink signal includes at least one of uplink data or uplink control information (UCI), and the uplink channel includes at least one of a physical uplink control channel (PUCCH) or a physical uplink shared channel (PUSCH), and
perform an uplink transmission based on the determined uplink signals, and the determined time units and/or uplink channels.
